(19) United States
(12) Patent Application Publication
(10) Pub. No.: US 2008/0195357 A1
(43) Pub. Date: Aug. 14, 2008

(54) METHOD AND SYSTEM FOR DETERMINING FIELD QUANTITIES IN A STRUCTURAL JOINT

(76) Inventors: Peter Allen Gustafson, Ypsilanti, MI (US); Anthony M. Waas, Ann Arbor, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/854,757

(22) Filed: Sep. 13, 2007

Related U.S. Application Data
(60) Provisional application No. 60/844,593, filed on Sep. 14, 2006.

(51) Int. Cl. G06G 7/64; G06F 17/50

(52) U.S. Cl. 703/1

(57) ABSTRACT

A Macroscopic Bonded Joint Finite Element (MBJFE) is capable of predicting field quantities in a bonded zone of a structural joint using a limited number of degrees of freedom. The MBJFE embeds an analytical solution directly within the element. Its stiffness and load response are based on non-linear shape functions that are dependent on load character. All critical terms are formulated as functions of a dimensionless mechanical load fraction allowing for solution via an iterative, non-linear finite element solver. The MBJFE is internally adaptive to internal and external conditions such as instantaneous external loads or internal temperatures.

### CROSS-REFERENCE TO RELATED APPLICATIONS

This application claims the benefit of U.S. provisional application Ser. No. 60/844,593, filed Sep. 14, 2006.

### STATEMENT REGARDING FEDERALLY SPONSORED RESEARCH OR DEVELOPMENT

This invention was made with government support under NCC3-989 awarded by the National Aeronautics and Space Administration. The government has certain rights in the invention.

### BACKGROUND

1. Field of the Invention

The invention relates to methods and systems for determining field quantities in structural joints.

2. Discussion

Recent advances in structural epoxies and adhesives have expanded the temperature range over which high performance fibrous composite materials can be used. In the structures composed of these materials, adhesively bonded joints are widely used due to improved load distribution, increased service life, reduced machining cost, and/or reduced complexity. These epoxies and adhesives, designed to provide structural integrity at high temperature, are subjected to severe operating environments. Furthermore, manufacturing processes subject these materials to broad temperature ranges during the different stages of the curing cycle. High stress gradients can exist near the edges of bonded joints due to mismatches in thermal expansion coefficients and elastic moduli. Therefore, components made from these materials carry a significant risk of adverse stress caused by differential thermal expansion, even when used at room temperature. Due to the increased use of composite materials and bonded joints, the need for efficient and effective thermo-mechanical analysis tools is greater than ever.

Continuum Finite Element (CFE) models rely on the presence of a meshed joint, where continuum elements represent the adherends, and the adhesive is represented by continuum elements or a discrete traction separation law. There is significant overhead in creating and analyzing joints using these and other continuum numerical methods. Mesh generation and manipulation is an obstacle for all but academic geometries. Mesh density is also a consideration, since the computational time for basic joints can be significant if non-linear material properties and material degradation criterion are included.

### SUMMARY

Kinematic or kinetic field quantities are determined for a structural joint. At least a portion of the structural joint is represented as a finite element. A shape function specific to the structural joint is embedded in the finite element. At least one kinematic and kinetic field quantity is determined based on the shape function specific to the structural joint.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic diagram of a symmetric double lap joint.

FIG. 2 is a schematic diagram of a generalized equilibrium parallelepiped.

FIG. 3A is another schematic diagram of a symmetric double lap joint.

FIG. 3B is a Macroscopic Bonded Joint Finite Element (MBJFE) representation of the symmetric double lap joint shown in FIG. 3A.

FIGS. 4A-4C are exemplary plots of stresses predicted by CFE and MBJFE models for an A1-A1 joint.

FIGS. 5A-5C are exemplary plots of stresses predicted by CFE and MBJFE models for an A1-AS4 joint.

FIG. 6A is a schematic diagram of an equilibrium element of the central adherend shown in FIG. 1.

FIG. 6B is a schematic diagram of an equilibrium element of the outer adherend shown in FIG. 1.

FIG. 6C is a schematic diagram of an equilibrium element of the adhesive shown in FIG. 1.

FIG. 6D is a schematic diagram of an equilibrium element of the left end post shown in FIG. 1.

FIG. 7 is a schematic diagram of a sub-element of the central adherend outside of the adhesively bonded section of the MBJFE representation of the symmetric double lap joint shown in FIG. 3B.

FIG. 8 is a schematic diagram of a sub-element of the adhesively bonded section of the MBJFE representation of the symmetric double lap joint shown in FIG. 3B.

### DETAILED DESCRIPTION

Conventional finite element (FE) techniques attempt to minimize mesh dependency. Conventional FE techniques, however, do not eliminate it. Due to mesh generation overhead and computational cost, it is often impractical and sometimes impossible to include joint models in sub-system, system, or vehicle level models.

According to embodiments of the present invention, an appropriate single finite element representation of at least a portion of a joint may provide adequate representation of the joint's behavior in the structure being modeled. An example of such a finite element is herein referred to as a Macroscopic Bonded Joint Finite Element (MBJFE). As explained below, a shape function specific to the structural joint is embedded in the finite element. Field quantities are then determined based on the shape function specific to the structural joint.

In considering the solution accuracy required for the MBJFE technique, it is recognized that there are many factors which affect the stress field and associated joint failure. These include adhesive spew or the geometric discontinuity and unbound stresses associated with stepwise geometries. Additionally, material non-linearity has a significant effect on the stress field, which requires a level of material characterization that is often not available early in an analysis cycle. Specialized joint analysis techniques (cohesive elements, the virtual crack closure technique, as well as others) require high level and additional material properties. In many circumstances, a designer has insufficient information or time to obtain a highly accurate solution, and instead would prefer a simple, directionally correct analysis. These types of analyses are often useful in tradeoff studies and to identify likely problem areas needing further study.

It may be considered adequate to perform linear elastic FE analysis with a basic geometry (i.e., square corners), similar to the Continuum Finite Element (CFE) analysis used for comparison here. In such a solution, however, the singular stress field causes a broad range of predicted stresses near the edges, particularly at the material interfaces.

It is apparent that the peel stress can be determined as a function of longitudinal position over most of the joint. In the critical areas near the edges of the joint, however, the predicted stress field varies widely and is mesh dependent. Even when non-linear material properties are assumed, which sometimes can ensure that the stress remains bounded, mesh dependency and convergence remains a concern. It is common practice that an analyst create several meshes at different densities in order to verify that the stress results have converged.

The MBJFE accurately represents the magnitude of the most critical stresses in the joint, while consistently and correctly predicting the trends from joint-to-joint. It does this with little to no mesh dependency and very little meshing overhead. Further, its use does not directly burden the user with the significant calculations typically associated with analytical solutions.

Derivation of the Advanced Shear and Peel Model

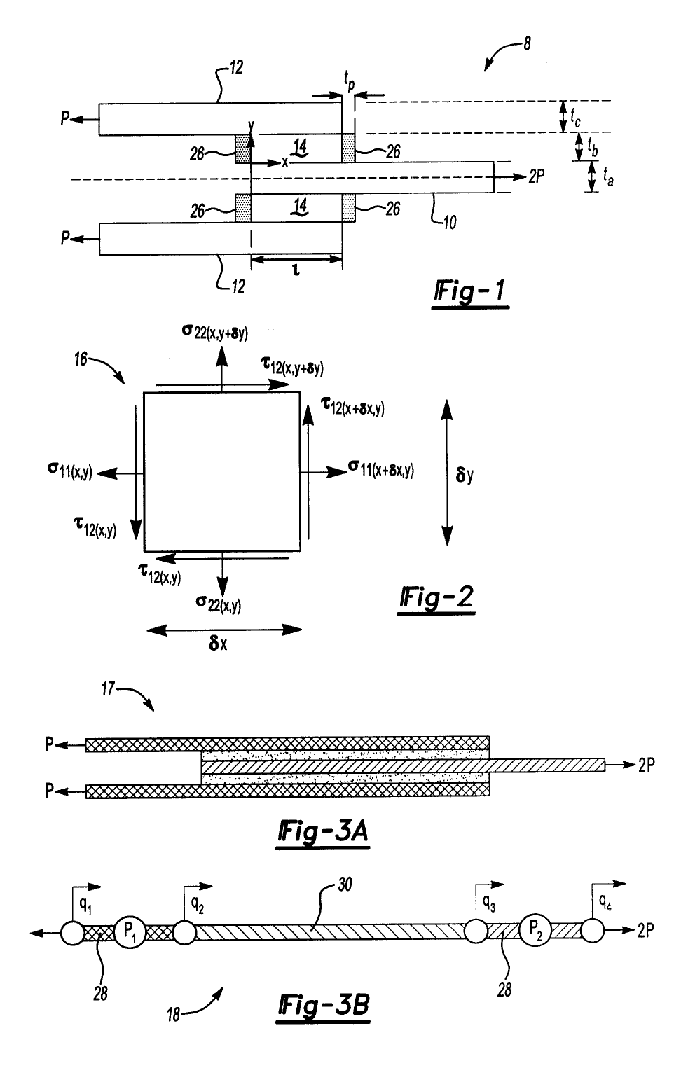

In Appendix B, a dimensionless solution is presented that is specific to a symmetric, orthotropic double lap joint subjected to thermo-mechanical loading. The lap joint 8 is schematically represented in FIG. 1. The central adherend 10 is referred to as material a. The outer adherend 12 is referred to as material c. The adhesive 14 is referred to as material b, which is thin in comparison to the adherends. The objective is to determine the equilibrium stress response to thermal and mechanical loading. The material is assumed to be linear elastic and orthotropic, with linear orthotropic thermal expansion. The joint is assumed to deform in plane strain, where the material constitutive response is given by Eq. (21) in Appendix A.

Examining a general parallelepiped 16 as shown in FIG. 2, force equilibrium in x and y directions can be written as:

ΣF₁=δx(σ₁₁(x+δx,y)−σ₁₁(x,y))+δx(τ₁₂(x,y+δy)−τ₁₂(x,y))=0

ΣF₂=δx(σ₂₂(x,y+δy)−σ₂₂(x,y))+δy(τ₁₂(x+δx,y)−τ₁₂(x,y))=0 (1)

which can be rewritten as the shear-normal stress relationship for each constituent:

$$\frac{\partial {σ}_{11} ( x , y )}{\partial x} = - \frac{\partial {τ}_{12} ( x , y )}{\partial y} \\ \frac{\partial {σ}_{22} ( x , y )}{\partial y} = - \frac{\partial {τ}_{12} ( x , y )}{\partial x} . \qquad ( 2 )$$

Several additional assumptions are made to ease the solution. The longitudinal normal stress in the adhesive is assumed to be zero, therefore Eqs. (2) dictates that the shear stress in the adhesive is a function of x only. For convenience, the remaining shear stress fields are assumed to vary linearly in y throughout the specimen, therefore Eqs. (2) dictate that the adherend longitudinal normal stresses are also functions of x only, and that the peel stresses are linear functions of x and y.

Traction free boundaries are present on the top and bottom surfaces. The centerline of the central adherend is free of shear due to symmetry. These requirements are expressed as:

$${τ}_{c 12} ( x , {t}_{b} + {t}_{c} ) = 0 , \\ {σ}_{c 22} ( x , {t}_{b} + {t}_{c} ) = 0 , \\ {τ}_{a 12} ( x , - \frac{{t}_{a}}{2} ) = 0. \qquad ( 3 )$$

Stress continuity at the joint interfaces requires the following:

σ_{b22(x,0)}=σ_{a22(x,0)},

σ_{v22(x,tb)}=σ_{b22(x,tb)},

τ_{b12(x,0)}=τ_{a12(x,0)},

τ_{c12(x,tb)}=τ_{b12(x,tb)}, (4)

Finally, longitudinal normal stress boundary conditions are imposed by the mechanical loads at the edges of central adherend a, and are expressed as:

$${σ}_{a 11 ( 0 )} = 0 , \\ {σ}_{a 11 ( l )} = \frac{2 P}{{t}_{a}} , \qquad ( 5 )$$

By sequentially writing a linear form for each stress component (using the stress field character described above), and by applying boundary and continuity conditions to determine the linear constants, equations can be written for each stress component in terms of the central adherend stress σₐ₁₁(x). The process is as described in Appendix B and is the same here, with the addition of several stress components (τₐ₁₂(x, y), σₐ₂₂(x, y), τ_{c12}(x, y), σ_{c22}(x, y)). The resulting stress equations are detailed on the left side of Table 1.

TABLE 1
Double lap joint stresses and virtual stresses expressed as functions of σₐ₁₁(x)

| Equilibrium Normal Stress | Virtual Normal Stress |
|---|---|
| σₐ₁₁(x) | \hat{σ}ₐ₁₁(x) |
| ${σ}_{c 11} ( x ) = \frac{P}{{t}_{c}} - \frac{{t}_{a} {σ}_{a 11} ( x )}{2 {t}_{c}}$ | ${\hat{σ}}_{c 11} ( x , y ) = - \frac{{t}_{a} {\hat{σ}}_{a 11} ( x )}{2 {t}_{c}}$ |
| ${σ}_{a 22} ( x , y ) = \frac{{d}^{2}}{{dx}^{2}} {σ}_{a 11} ( x ) ( \frac{{y}^{2} + {t}_{a} y}{2} - \frac{{t}_{a} ( {t}_{ c} + 2 {t}_{b} )}{4} )$ | ${\hat{σ}}_{a 22} ( x , y ) = \frac{{d}^{2}}{{dx}^{2}} {\hat{σ}}_{a 11} ( x ) ( \frac{{y}^{2} + {t}_{a} y}{2} - \frac{{t}_{a} ( {t}_{c} + 2 {t}_{b} )}{4} )$ |
| ${σ}_{b 22} ( x , y ) = \frac{{t}_{a} ( \frac{{d}^{2}}{{dx}^{2}} {σ}_{a 11} ( x ) ) ( 2 y - {t}_{c} - 2 {t}_{b} )}{4}$ | ${\hat{σ}}_{a 22} ( x , y ) = \frac{{t}_{a} ( \frac{{d}^{2}}{{dx}^{2}} {\hat{σ}}_{a 11} ( x ) ) ( 2 y - {t}_{c} - 2 {t}_{b} )}{4}$ |
| ${σ}_{c 22} ( x , y ) = - \frac{{t}_{a} ( \frac{{d}^{2}}{{dx}^{2}} {σ}_{a 11} ( x ) ) {( y - {t}_{c} - {t}_{b} )}^{2}}{4 {t}_{c}}$ | ${\hat{σ}}_{c 22} ( x , y ) = \frac{{t}_{a} ( \frac{{d}^{2}}{{dx}^{2}} {\hat{σ}}_{a 11} ( x ) ) {( y - {t}_{c} - {t}_{b} )}^{2}}{4 {t}_{c}}$ |
| Equilibrium Shear Stress | Virtual Shear Stress |
| ${τ}_{a 22} ( x , y ) = - \frac{\frac{d}{dx} {σ}_{a 11} ( x ) ( 2 y + {t}_{a} )}{2}$ | ${\hat{τ}}_{a 12} ( x , y ) = - \frac{\frac{d}{dx} {\hat{σ}}_{a 11} ( x ) ( 2 y + {t}_{a} )}{2}$ |
| ${τ}_{a 12} ( x ) = - \frac{{t}_{a} ( \frac{d}{dx} {σ}_{a 11} ( x ) )}{2}$ | ${\hat{τ}}_{b 12} ( x , y ) = - \frac{{t}_{a} ( \frac{d}{dx} {\hat{σ}}_{a 11} ( x ) )}{2}$ |
| ${τ}_{c 22} ( x , y ) = \frac{{t}_{a} ( \frac{d}{dx} {σ}_{a 11} ( x ) ) ( y - {t}_{c} - {t}_{b} )}{2 {t}_{c}}$ | ${\hat{τ}}_{c 12} ( x , y ) = \frac{{t}_{a} ( \frac{d}{dx} {\hat{σ}}_{a 11} ( x ) ) ( y - {t}_{c} - {t}_{b} )}{2 {t}_{c}}$ |
| Equilibrium End Post Stress | Virtual End Post Stress |
| ${σ}_{p 22} ( \overline{x} = 0 , \text{y} ) = \frac{{t}_{a} ( \frac{d}{dx} {σ}_{a 11} ( x ) ) ( y - {t}_{b} )}{2 {t}_{p}}$ | ${\hat{σ}}_{p 22} ( \overline{x} = 0 , \text{y} ) = \frac{{t}_{a} ( \frac{d}{dx} {\hat{σ}}_{a 11} ( x ) ) ( y - {t}_{b} )}{2 {t}_{p}}$ |
| ${σ}_{p 22} ( \overline{x} = 1 , \text{y} ) = \frac{{t}_{a} ( \frac{d}{dx} {σ}_{a 11} ( x ) ) ( y - {t}_{b} )}{2 {t}_{p}}$ | ${\hat{σ}}_{p 22} ( \overline{x} = 1 , \text{y} ) = - \frac{{t}_{a} ( \frac{d}{dx} {\hat{σ}}_{a 11} ( x ) ) ( y - {t}_{b} )}{2 {t}_{p}}$ |

In addition to the boundary conditions specified in Eqs. (3), Eqs. (4), and Eqs. (5), the adhesive edge shear stress is forced to zero using the end post technique described in Appendix B. The stresses in the edge posts also listed on the left side of Table 1.

The solution for the central adherend normal stress (σₐ₁₁(x)) is carried out by application of the principle of virtual forces, as described in detail in Appendix A. In summary, for each stress component (each is a function of σₐ₁₁(x)), a corresponding virtual stress component is written in terms of the virtual normal stress \hat{σ}ₐ₁₁(x). These virtual stress components are shown on the right side of Table 1. By integrating potential energy over the volume of the joint and minimizing for any admissible \hat{σ}ₐ₁₁(x), the central adherend stress field is determined as a function of all material properties and loads. With subsequent grouping of all material terms according to their order of derivative (defined as β and γ in Eq. (6)) and the loads according to thermal and mechanical contributions of the total load (defined as φ_{T} and φ_{P} respectively in Eq. (6)), the differential equation can be written as:

$$\frac{{\partial }^{4} {σ}_{a 11} ( x )}{\partial {x}^{4}} + β \frac{{\partial }^{2} {σ}_{a 11} ( x )}{\partial {x}^{2}} + γ {σ}_{a 11} ( x ) + {φ}_{T} + {φ}_{P} = 0. \qquad ( 6 )$$

Eq. (6) is identical in form to the solution given in Appendix B. The material constants β and γy, as well as the load constants φ_{T} and φ_{P}, however, are more complex due to the increase in the retained stress components in the potential energy minimization. The improved accuracy of this model over its predecessor is a direct result of the addition of these previously neglected terms.

With an equation for the central adherend stress (σₐ₁₁(x)), all stress components can easily be determined using the equations in Table 1. The non-dimensionalization and load normalization of (6) is possible, and doing so provides a mechanism for separation of the responses to mechanical and thermal loads. This has great benefits for the MBJFE solution when used with an iterative solver. Therefore, without explicitly reporting the dimensional material and load constants (β, γ, φ_{T}, φ_{P}), non-dimensionalization and load normalization is done so as to conform to the solution provided in Appendix B. The dimensionless and load normalized material, load, and stress terms are defined as follows:

$$\overline{x} = \frac{x}{l} , \\ \overline{β} = {l}^{2} β , \\ \overline{γ} = {l}^{4} γ , \\ {\overline{φ}}_{T} = {φ}_{T} \frac{{l}^{4}}{{E}_{a 11}} , \\ {\overline{φ}}_{P} = {φ}_{P} \frac{{l}^{4}}{{E}_{a 11}} , \\ {\overline{\overline{φ}}}_{total} = {\overline{φ}}_{P} + {\overline{φ}}_{T} , \\ {\overline{\overline{φ}}}_{P} = \frac{{\overline{φ}}_{P}}{{\overline{\overline{φ}}}_{total}} , \\ {\overline{\overline{σ}}}_{κ ij ( \overline{x} )} = \frac{{σ}_{κ ij ( l \overline{x} )}}{{E}_{a 11} {\overline{\overline{φ}}}_{total}} . \qquad ( 7 )$$

In Eq. (7), x̅ is the dimensionless spatial coordinate measured from the left edge of the joint, β̅ and γ̅ are dimensionless material parameters, and φ_{P} and φ_{T} are the dimensionless mechanical and thermal loads respectively. A dimensionless total load is defined as φ̅ₜₒₜₐₗ, which is used to further normalize the stresses σ̅_{κij( x̅)}. Similarly, a mechanical fraction of the dimensionless total load is defined as φ_{P}. Each of the terms in Eq. (7) are explicitly defined according to the constitutive and load quantities in Appendix A. Eq. (8) from Appendix B is written as the form most suitable for the MBJFE:

$${{σ}^{\overline{\_}}}_{a 11} ( \overline{x} , {\overline{\overline{φ}}}_{P} ) = \overline{\overline{A}} ( {\overline{\overline{φ}}}_{P} ) {e}^{{\overline{λ}}_{1} \overline{x}} + \overline{\overline{B}} ( {\overline{\overline{φ}}}_{P} ) {e}^{- {\overline{λ}}_{1} \overline{x}} + \overline{\overline{C}} ( {\overline{\overline{φ}}}_{P} ) {e}^{{\overline{λ}}_{3} \overline{x}} + \overline{\overline{D}} ( {\overline{\overline{φ}}}_{P} ) {e}^{- {\overline{λ}}_{3} \overline{x}} - \frac{1}{γ} . \qquad ( 8 )$$

In Eq. (8), the material parameters are recast in the form of the roots of the bi-quadratic differential equation.

$${\overline{λ}}_{\vert 13 \vert}^{2} = \frac{- \overline{β} \pm \sqrt{{\overline{β}}^{2} - 4 \overline{γ}}}{2} . \qquad ( 9 )$$

The equations for the dimensionless basis coefficients ( A̅( φ̅_{P}), B̅( φ̅_{P}), C̅( φ̅_{P}), D̅( φ̅_{P})) are listed below:

$$\overline{\overline{A}} ( {\overline{\overline{φ}}}_{P} ) = \frac{{μ}_{3} {μ}_{{A}_{P}}}{{μ}_{1} {μ}_{2}} {\overline{\overline{φ}}}_{P} + \frac{{μ}_{{A}_{T}}}{{μ}_{1}} , \\ \overline{\overline{B}} ( {\overline{\overline{φ}}}_{P} ) = \frac{{μ}_{3} {μ}_{{B}_{P}}}{{μ}_{1} {μ}_{2}} {\overline{\overline{φ}}}_{P} + \frac{{μ}_{{B}_{T}}}{{μ}_{1}} , \\ \overline{\overline{C}} ( {\overline{\overline{φ}}}_{P} ) = \frac{{μ}_{3} {μ}_{{C}_{P}}}{{μ}_{1} {μ}_{2}} {\overline{\overline{φ}}}_{P} + \frac{{μ}_{{C}_{T}}}{{μ}_{1}} , \\ \overline{\overline{D}} ( {\overline{\overline{φ}}}_{P} ) = \frac{{μ}_{3} {μ}_{{D}_{P}}}{{μ}_{1} {μ}_{2}} {\overline{\overline{φ}}}_{P} + \frac{{μ}_{{D}_{T}}}{{μ}_{1}} , \qquad ( 10 )$$

In Eq. (10), the coefficients ( A̅( φ̅_{P}), B̅( φ̅_{P}), C̅( φ̅_{P}), D̅( φ̅_{P})) are linear functions of the mechanical fraction of the total load ( φ̅_{P}) and several variables denoted by μ which are combinations of the material parameters. These are listed in the Appendix A. In combination, Eq. (8) and Eq. (10) effectively separate the thermal and mechanical responses.

The presented solution in this section would be incomplete without additional information provided in Appendix B, particularly with respect to the application of boundary conditions which bridge between the differential equation (Eq. (6)) and the stress solution (Eq. (8)). Further, Appendix B provides complete detail regarding the load normalized form of Eq. (8).

### Formulation of the Finite Element

The MBJFE 18 schematically shown in FIG. 3B is derived in Appendix C from the symmetric double lap joint 17 schematically shown in FIG. 3A. The element 18 is a 1D element, with all displacement degrees of freedom being oriented along the 1-axis. Two of the displacement degrees of freedom, q₁ and q₄, are external degrees of freedom which connect the joint element to the external structure. The remaining displacement degrees of freedom are internal to the element, and are used in conjunction with Lagrange multipliers to determine the mechanical loading fraction, φ̅_{P}, required for determination of the stress and strain fields governed by Eq. (8). The mechanical load that is carried across the joint is calculated using internal degrees of freedom, P₁ and P₂.

The element 18 in FIG. 3B is composed of three subelements. The outer subelements span q₁-q₂, and q₃-q₄. These subelements are essentially truss elements, and their principal purpose is to establish the mechanical load as an internal degree of freedom as described in Appendix C, where their contribution to the element stiffness is given in detail. The joint section subelement spans q₂-q₃, and is responsible for predicting the relevant joint stresses as well as correctly representing the stiffness of the joint. The form of the stiffness matrix is developed in Appendix C.

### Stiffness and Load Contribution of the Adhesively Bonded Section

The subelement stiffness matrix is directly dependent on the load-displacement response of the central and outer adherends. The strain in these adherends is related, via the material constitutive response given in Eq. (21), to the stress fields known from Eq. (8) and Table 1. These strains are related to the stiffness matrix by embedded shape functions derivatives, and this relationship is given in Appendix C as Eq. (11).

$${K}_{e} = \frac{{\sum }_{κ} {E}_{κ 11} {\int }_{{y}_{κ 0}}^{{y}_{κ 1}} {\int }_{0}^{1} {B}_{κ}^{2} ( \overline{x} , {\overline{\overline{φ}}}_{P} ) d \overline{x} d {y}_{κ}}{{l}_{e}} [ \begin{matrix}1 & - 1 \\ - 1 & 1\end{matrix} ] \qquad ( 11 )$$

In the discrete space of the FE model, the known or desired quantities are the applied temperature change, ΔT, (and/or moisture concentration, etc.) and the nodal loads and displacements (and/or velocities, etc.). The load quantities must be recast into their non-dimensional forms to conform to the stress equations given above. Non-dimensionalizing constants

$$( \frac{Θ}{{θ}_{Δ T}} and \frac{Θ}{{θ}_{P}} )$$

are defined so that:

$$Δ T = \frac{Θ}{{θ}_{Δ T}} {\overline{φ}}_{T} , \\ P = \frac{Θ}{{θ}_{P}} {\overline{φ}}_{P} . \qquad ( 12 )$$

Applying Eqs. (12) to the known stress field and constitutive law, the strain can be written as a linear function of the total load φ̅ₜₒₜₐₗ:

$$\frac{{ɛ}_{a 11} ( \overline{x} , {\overline{\overline{φ}}}_{P} , {\overline{\overline{φ}}}_{total} )}{{\overline{\overline{φ}}}_{total}} = ( 1 - {v}_{a 13} {v}_{a 31} ) ( {e}^{- {\overline{λ}}_{3} \overline{x}} \overline{\overline{D}} ( {\overline{\overline{φ}}}_{P} ) + {e}^{{\overline{λ}}_{3} \overline{x}} \overline{\overline{C }} ( {\overline{\overline{φ}}}_{P} ) + {e}^{- {\overline{λ}}_{1} \overline{x}} \overline{\overline{B}} ( {\overline{\overline{φ}}}_{P} ) + {e}^{{\overline{λ}}_{1} \overline{x}} \overline{\overline{A}} ( {\overline{\overline{φ}}}_{P} ) - \frac{1}{\overline{γ}} ) + \frac{Θ}{{θ}_{Δ T}} ( 1 - {\overline{\overline{φ}}}_{P} ) ( {α}_{a 33} {v}_{a 31} + {α}_{a 11} ) , \\ \frac{{ɛ}_{c 11} ( \overline{x} , {\overline{\overline{φ}}}_{P} , {\overline{\overline{φ}}}_{total} )}{{\overline{\overline{φ}}}_{total}} = \frac{{E}_{a 11} {t}_{a} ( {v}_{c 13} {v}_{c 31} - 1 )}{2 {E}_{c 11} {t}_{c}} ( {e}^{- {\overline{λ}}_{3} \overline{x}} \overline{\overline{D}} ( {\overline{\overline{φ}}}_{P} ) + {e}^{{\overline{λ}}_{3} \overline{x}} \overline{\overline{C }} ( {\overline{\overline{φ}}}_{P} ) + {e}^{- {\overline{λ}}_{1} \overline{x}} \overline{\overline{B}} ( {\overline{\overline{φ}}}_{P} ) + {e}^{{\overline{λ}}_{1} \overline{x}} \overline{\overline{A}} ( {\overline{\overline{φ}}}_{P} ) ) + \frac{Θ}{{θ}_{Δ T}} ( 1 - {\overline{\overline{φ}}}_{P} ) ( {α}_{c 11} + {α}_{c 33} {v}_{c 31} ) + \frac{1}{{E}_{c 11} {t}_{c}} ( 1 - {v}_{c 13} {v}_{c 31} ) ( \frac{{E}_{a 11} {t}_{a}}{2 \overline{γ}} + \frac{{\overline{\overline{φ}}}_{P} \frac{Θ}{{θ}_{P}}}{1} ) . \qquad ( 13 )$$

It is assumed that the total elongation is the same for the adherends, therefore the two elongation equations are written as:

$${q}_{e} = ( \frac{d x}{d \overline{x}} ) {\int }_{0}^{1} {ɛ}_{a 11} ( \overline{x} , {\overline{\overline{φ}}}_{P} , {\overline{\overline{φ}}}_{total} ) d \overline{x} , \\ {q}_{e} = ( \frac{d x}{d \overline{x}} ) {\int }_{0}^{1} {ɛ}_{c 11} ( \overline{x} , y , {\overline{\overline{φ}}}_{P} , {\overline{\overline{φ}}}_{total} ) d \overline{x} , \qquad ( 14 )$$

where the subelement elongation q₁ is defined as:

qₑ=q₄−q₃. (15)

In Eq. (14), the elongation is written as a function of the non-dimensional total load, φ̅ₜₒₜₐₗ. The total load is not known a priori and must be eliminated in favor of an available quantity (the total elongation qₑ) so that a stiffness matrix can be calculated. This is accomplished by applying the boundary condition to the result of Eq. (14):

$$( \frac{d x}{d \overline{x}} ) {\int }_{0}^{\overline{x}} {ɛ}_{a 11} ( \overline{x} , {\overline{\overline{φ}}}_{P} , {\overline{\overline{φ}}}_{total} ) d \overline{x} {\vert}_{\overline{x} = 0} = 0 , \\ ( \frac{d x}{d \overline{x}} ) {\int }_{0}^{\overline{x}} {ɛ}_{a 11} ( \overline{x} , {\overline{\overline{φ}}}_{P} , {\overline{\overline{φ}}}_{total} ) d \overline{x} {\vert}_{\overline{x} = 1} = {q}_{e} , \\ ( \frac{d x}{d \overline{x}} ) {\int }_{0}^{\overline{x}} {ɛ}_{c 11} ( \overline{x} , {\overline{\overline{φ}}}_{P} , {\overline{\overline{φ}}}_{total} ) d \overline{x} {\vert}_{\overline{x} = 0} = 0 , \\ ( \frac{d x}{d \overline{x}} ) {\int }_{0}^{\overline{x}} {ɛ}_{c 11} ( \overline{x} , {\overline{\overline{φ}}}_{P} , {\overline{\overline{φ}}}_{total} ) d \overline{x} {\vert}_{\overline{x} = 1} = {q}_{e} , \qquad ( 16 )$$

Specifically, the elongation is zero when x̅=0(since x̅=0 is the reference from which elongation is measured), and the total elongation is qₑ when x̅=1. Applying these boundary conditions and solving for the total load φ̅ₜₒₜₐₗ as a function of elongation qₑ (this is done for each strain equation), total load can be replaced in Eq. (13) with the following:

φ̅ₜₒₜₐₗ_{ₐ}= Φ̅ₐqₑ,

φ̅ₜₒₜₐₗ_{_{c}}= Φ̅_{c}qₑ, (17)

where the constants ( φ̅ₐ, Φ̅_{c}) are detailed in Appendix A. Substituting Eq. (17) into Eq. (13), the displacement field is known in terms of total elongation and the shape functions and shape functions derivatives can now be written for each adherend:

$${u}_{a} ( \overline{x} , {\overline{\overline{φ}}}_{P} , {q}_{e} ) = {N}_{a} ( \overline{x} , {\overline{\overline{φ}}}_{P} ) {q}_{e} , \\ {u}_{c} ( \overline{x} , {\overline{\overline{φ}}}_{P} , {q}_{e} ) = {N}_{c} ( \overline{x} , {\overline{\overline{φ}}}_{P} ) {q}_{e} , \\ {B}_{a} ( \overline{x} , {\overline{\overline{φ}}}_{P} ) = \frac{d}{d \overline{x}} {N}_{a} ( \overline{x} , {\overline{\overline{φ}}}_{P} ) , \\ {B}_{c} ( \overline{x} , {\overline{\overline{φ}}}_{P} ) = \frac{d}{d \overline{x}} {N}_{c} ( \overline{x} , {\overline{\overline{φ}}}_{P} ) . \qquad ( 18 )$$

The complete shape functions in Eq. (18) are detailed in the Appendix A.

Having established the appropriate shape functions, the stiffness matrix can now be integrated numerically using Eqs. (11). Additionally, the sub-element load vector is derived in Appendix C as Eq. (19), and can now be calculated. In Eqs. (11) and Eq. (19), the summation includes both adherends (κ=a, c).

$$\overline{F} = P \{ \begin{matrix}- 1 \\ 1\end{matrix} \} + {\sum }_{κ} {α}_{κ 11} {E}_{κ 11} ( {\int }_{{y}_{0}}^{{y}_{1}} {\int }_{0}^{1} {B}_{κ} ( \overline{x} , {\overline{\overline{φ}}}_{P} ) d \overline{x} d {y}_{κ} ) Δ T \{ \begin{matrix}- 1 \\ 1\end{matrix} \} \qquad ( 19 )$$

The final requirement for element calculations is knowledge of the mechanical load P, used to determine the load character φ̅ₚ of the bonded section sub-element. This is accomplished by causing this load to be an internal degree of freedom using Lagrange multipliers. Here, the load becomes P₁.

The described MBJFE is subject to an instantaneous internal damage state and an associated internal configuration. The range of this damage state extends from a perfect joint to a fully damaged joint.

The MBJFE is adaptive to this internal state of damage through the internal configuration of the element and the constitutive relationship. For example, in one implementation a perfect joint has an initial length and a corresponding configuration (i.e. internal node positions, sub-element lengths, and non-linear shape functions). See, Eqs. (7) and (13) and FIGS. 7 and 8. Upon loading, a damage criterion (based on kinetic or kinematic quantities) is evaluated. If that damage criterion is met, the element reconfigures internally by decreasing the effective load carrying length of the joint (adjusting the internal node positions, sub-element lengths, and non-linear shape functions) or by adjusting the constitutive relationship. See Eqs. (21). In doing so, the MBJFE is “damaged” and the internal kinematics and kinetics are appropriately adjusted. As the solution proceeds, the instantaneous configuration of the MBJFE adapts to the complete damage history of the joint.

### The Abaqus® Subroutine

The sub-element stiffness matrices and load vectors, developed above and in Appendix C, are assembled into element matrices with 6 DOFs using a standard assembly technique. The formulation requires an iterative solution, since the mechanical load carried by the joint is not known in general. Therefore, the shape functions developed above have been implemented as a user element subroutine (UEL) for the commercial non-linear FE package Abaqus®. These shape functions, however, may also be implemented in any available finite element analysis package. Because the UEL subroutine is a specific implementation of an MBJFE, this subroutine will here after be referred to as MBJFE.

The displacement, stress and strain fields are dependent on the ratio of the mechanical to thermal load through the mechanical load fraction φ̅_{P}. Therefore, this ratio is calculated by the MBJFE. The mechanical load P across the joint section is calculated using the two internal force DOFs P₁ and P₂. These forces should be equal if no body forces are applied, however they can be different during incrementation and have small differences even after the solution completes, according to the specified convergence tolerances. Therefore, the two values are averaged for the purposes of calculating φ̅_{P}. During the initial increment, P₁ and P₂ are set to zero unless a boundary condition is applied. The thermal load, ΔT, is assumed to be constant through the element and is applied as a user distributed load into the MBJFE. The initial increment of ΔT is determined automatically by the solver based on the increment load step algorithms, as chosen by the user. The default is a linear ramping of the temperature change over the step.

During each call to the MBJFE, the mechanical load fraction φ̅_{P} is calculated based on the load of the increment, and the stiffness matrix and load vector are integrated numerically using a modified midpoint rule. The modification offsets the integration point by ½ interval so that the extremes of the joint section are included in the integration. Equal weighting is given to each interval, except that the end points have a weighting ½ of the other intervals.

The field quantities are calculated from Table 1 at each integration point, based on the calculated ΔT and P₁ for the increment. The user specifies the number of integration points to be the number of stress prediction points desired in the joint. In this way, all stress and strain quantities of interest are calculated in a manner consistent with the shape function displacement field.

### FE Output

The stress prediction provided by the MBJFE has been compared to a plane strain CFE model. In the case of the MBJFE, the entire model consists of a single element. Several elements, however, may also be used. In the case of the continuum model, a 2D mesh has been generated. Both models are based on the ASTM International double lap joint. Table 2 compares the number of nodes, elements and degrees of freedom in the CFE and MBJFE models of the double lap joint.

TABLE 2
Model size for ASTM double lap joints

| Model | Nodes | Elements | DOFs |
|---|---|---|---|
| CFE | ~22100 | ~21600 | ~44300 |
| MBJFE | 4 | 1 | 6 |

Assumed geometries are given in Table 3(a).

TABLE 3(a)
Geometric assumptions for model comparison (mm).

| Component | Thickness | Length |
|---|---|---|
| Outer Adherend | 1.6 | 76.2 |
| Adhesive | 0.2 | 12.7 |
| Central Adherend | 3.2 | 76.2 |

The solver used is Abaqus® Standard, and the continuum mesh consists entirely of linear plain strain elements (CPE4). Half of the joint is modeled due to symmetry. Loading is specified as listed in Table 3(b), where the mechanical load is applied far away from the lap joint and the thermal load is applied to all nodes.

TABLE 3(b)
Loading assumptions for model comparison.

| Load Type | Value |
|---|---|
| P (N · mm⁻¹) | 10 |
| ΔT (° C.) | 10 |

Displacement symmetry constraints are enforced along the mid-plane of the central adherend. Non-linear geometric stiffness is assumed.

Aluminum (Al) is used as the central adherend in all models; the outer adherends are Titanium (Ti), and AS4/3501-6 (AS4). For simplicity, the adhesive properties are assumed to be isotropic, and are estimated base on Cytec FM300 adhesive. The assumed material properties are summarized in Table 4 of Appendix A. The shear stresses from the continuum model are reported at the centerline of the adhesive, which is the most representative location for comparison with the uniform shear stress predicted by the MBJFE. The peel stress in the continuum model is reported at the interface between the adhesive and the central adherend. The choice of this location has a large effect on the predicted peel stress. The adhesive to central adherend interface (a-b) comparison location is chosen because the MBJFE model can be used as a measure of the magnitude of the singularity present at this location. The peel stress reported from the MBJFE is the average peel stress through the thickness (the stress equation is evaluated at y=t_{b}/2).

### Comparison of MBJFE and CFE Models

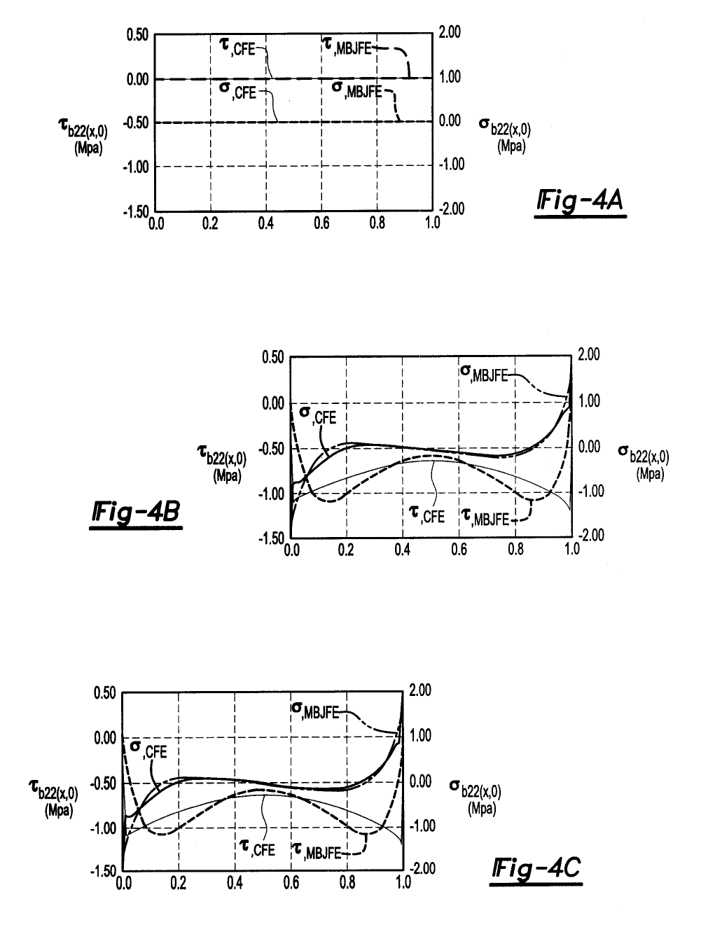

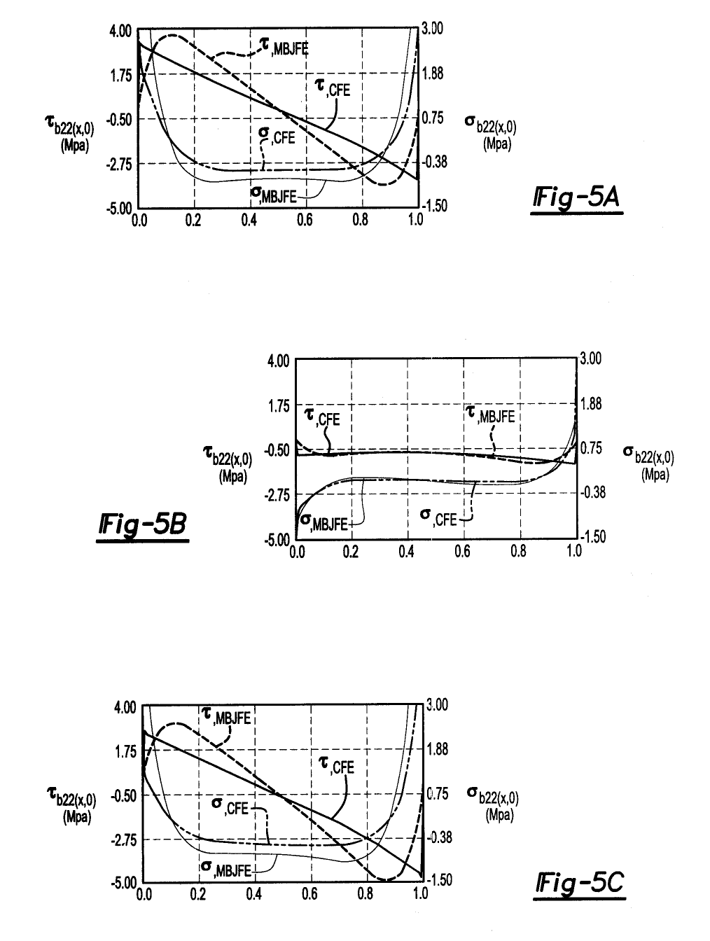

Plots of the stresses predicted by the CFE and MBJFE models are shown in FIGS. 4A-5C. FIGS. 4A-4C show the predictions for an A1-A1 double lap joint. When this joint is subjected to thermal loading, as is shown in 4A, both models predict that the stress is negligible. This stress result is intuitive, since the two adherends have identical thermal expansion coefficients. FIG. 4B shows shear and peel stress predictions for the A1-A1 when joint subjected to mechanical loading, where good agreement is found in both figures. The peak shear stress predicted by the MBJFE is similar to that predicted by the continuum model, though there is a difference in predicted peak location. The peel stress predicted by the MBJFE is in adequate agreement with the continuum model, and its value does not suffer from any mesh dependency. FIG. 4C shows shear and peel stress predictions for the A1-A1 joint when subjected to mixed loading, which is almost identical to the mechanical load predictions for this joint.

The MBJFE solution is orthotropic, and an example of a composite application is shown in FIGS. 5A-5C. The figures show an A1-AS4 joint subjected to thermal, mechanical, and mixed loading. The laminate shown in FIGS. 5A-5C has fibers oriented longitudinally (0°). The figures show that the MBJFE solution is in adequate agreement with the continuum solution.

Based on the cumulative agreement shown in FIGS. 4A-5C, it can be concluded that the MBJFE adequately predicts the shear stress in a double lap joint. The peel stress predicted by the MBJFE model is found to be consistently in agreement with the magnitude of the (unconverged) singular stress field in all figures (at the mesh density used in this comparison). Therefore, it can be used as a mesh independent indicator of peel stress magnitude, useful for joint-to-joint comparison.

To implement these techniques for a different joint, the user would obtain or calculate, as in Eqs. (1)-(10), an appropriate displacement field for that joint. Using that displacement field and its derivatives, the user would formulate an appropriate shape function(s) specific to that joint, as in Eqs. (13)-(18). With the formulated shape function(s), the user could then calculate the load vector(s) and stiffness matrix(cies), as in Eqs. (11) and (19).

### Conclusion

A Macroscopic Bonded Joint Finite Element has been described. It is capable of predicting the lap joint field quantities in the bonded zone while using only six degrees of freedom. It does so without burdening the user with mesh dependency or significant meshing overhead. The described MBJFE accomplishes this task by embedding an analytical solution directly within the element. Its stiffness and load response are based on non-linear shape functions that are dependent on the load character. All critical terms are formulated as functions of the dimensionless mechanical load fraction, φ̅_{P}, allowing for solution via an iterative, non-linear FE solver. Therefore, the element is internally adaptive to internal and external conditions such as instantaneous external loads or internal temperatures. To demonstrate its capability, the element has been implemented as a user element subroutine in the commercial finite element package Abaqus®.

Based on comparison with a traditional FE solution, the MBJFE has been shown to be capable of adequately predicting stress and strain due to thermal and mechanical loads in a single, four noded element with six degrees of freedom. With this element, initial sizing and trade studies can be accomplished with a greatly reduced meshing investment, as well as a reduction in computation time, when compared with the standard finite element method.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

### Nomenclature

lₑ Length of the lap sub-element, m
t_{κ} Material thicknesses of component κ, m
x,y Cartesian coordinates measured from the lower left corner of the adhesive, m
σ_{κ11(x)} Longitudinal stress in component κ, Pa
σ_{κ22(x,y)} Transverse stress in component κ, Pa
τ_{κ12(x)} Shear stress in component κ, Pa
\hat{σ}_{κ11(x)} Longitudinal virtual stress in component κ
\hat{σ}_{κ22(x,y)} Transverse virtual stress in component κ
\hat{τ}_{κ12(x)} Shear virtual stress in component κ
E_{κii} Orthotropic engineering moduli of component κ; Pa
G_{bij} Orthotropic shear modulii of the adhesive, Pa
α_{κii} Orthotropic thermal expansion coefficient of component κ; ° C.⁻¹
υ_{κij} Poisson's ratios of component κ
P Mechanical load applied to the joint, per unit depth, N m⁻¹
P₁,P₂ Element internal mechanical load DOFs, per unit depth, N m⁻¹
ΔT Temperature change from a reference temperature, ° C.
x̅ Normalized coordinate x/lₑ measured from the left edge of the joint
β̅, γ̅, λ̅₁, λ̅₃ Dimensionless system parameters φ̅_{P} Dimensionless mechanical load parameter
φ̅_{T} Dimensionless thermal load parameter
φ̅ₜₒₜₐₗ Dimensionless total load parameter
φ̅_{P} Dimensionless mechanical load fraction
A̅, B̅, C̅, D̅ Dimensionless basis coefficients
\overline{ \overline{Φ}}ₐ, \overline{ \overline{Φ}}_{c} Intermediate variables Ξ̅_{z}, Ξ̅_{c} Intermediate variables
q₁,q₂,q₃,q₄ Nodal displacement degrees of freedom
qₑ Subelement extension degree of freedom
Nₐ, N_{c} Element shape functions
Bₐ,B_{c} Element shape function derivatives

### Subscripts

[ ] the or operator, i.e., [12] is 1 or 2 (no sum)
κ κ=[abcp] (no sum) Subscript representing central adherend (a), adhesive (b), outer adherend (c), and end post (p) respectively
ii i=[123] (no sum)
ii i,j=[123] where i≠j (no sum)

### APPENDIX A

### Extended Description of the Virtual Work Calculations

The principal of virtual work calculations are briefly summarized below. Equilibrium relations derived in the section entitled “Derivation of the Advanced Shear and Peel Model” are given in Table 1 above, as well as their associated virtual stress quantities. In Table 1, all virtual stress quantities can be written in terms of the central adherend virtual stress \hat{σ}ₐ₁₁(x). The principal of virtual work is applied using:

$$δ W = {\sum }_{i} \int ( {\hat{σ}}_{i} {ɛ}_{i} ) d {V}_{i} = 0 , \qquad ( 20 )$$

where i represents the quantities listed in Table 1 for each solution. The plane strain constitutive equation for material κ is governed by:

$$\{ \begin{matrix}{ɛ}_{κ 11 ( x )} \\ {ɛ}_{κ 22 ( x )} \\ {γ}_{κ12 ( x )}\end{matrix} \} = [ \begin{matrix}\frac{1 - {v}_{κ13} {v}_{κ31}}{{E}_{κ 11}} & - \frac{{v}_{κ23} {v}_{κ31} + {v}_{κ21}}{{E}_{κ22}} & 0 \\ - \frac{{v}_{κ13} {v}_{κ32} + {v}_{κ12}}{{E}_{κ11}} & \frac{1 - {v}_{κ23} {v}_{κ32}}{{E}_{κ22}} & 0 \\ 0 & 0 & \frac{1}{{G}_{κ12}}\end{matrix} ] \{ \begin{matrix}{σ}_{κ 11 ( x )} \\ {σ}_{κ 22 ( x )} \\ {τ}_{κ12 ( x )}\end{matrix} \} + [ \begin{matrix}{α}_{κ 33} {v}_{κ 31} + {α}_{κ11} \\ {α}_{κ33} {v}_{κ32} + {α}_{κ22} \\ 0\end{matrix} ] Δ T \qquad ( 21 )$$

Eq. (20) applies for an arbitrary virtual stress \hat{σ}ₐ₁₁(x). The field equations and boundary terms of the solution become apparent when integration of Eq. (20) is performed by parts.

### Shape Functions and Derivatives Within the Bonded Region

The shape functions and their derivatives are expressed with the following equations:

$$\frac{{N}_{a} ( \overline{x} , {\hat{\overline{φ}}}_{P} )}{{l}_{e} {\overline{Φ}}_{a}} = - ( 1 - {v}_{a 13} {v}_{a 31} ) ( \frac{{e}^{- {\overline{λ}}_{3} \overline{x}} \overline{\overline{D}} ( {\overline{\overline{φ}}}_{P} )}{{\overline{λ}}_{3}} + \frac{- {e}^{{\overline{λ}}_{3} \overline{x}} \overline{\overline{C}} ( {\overline{\overline{φ}}}_{P} )}{{\overline{λ}}_{3}} + \frac{{e}^{- {\overline{λ}}_{1} \overline{x}} \overline{\overline{B}} ( {\overline{\overline{φ}}}_{P} )}{{\overline{λ}}_{1}} + \frac{- {e}^{{\overline{λ}}_{1} \overline{x}} \overline{\overline{A}} ( {\overline{\overline{φ}}}_{P} )}{{\overline{λ}}_{1}} + \frac{\overline{x}}{\overline{γ}} ) + \overline{x} \frac{Θ}{{θ}_{Δ T}} ( 1 - {\overline{\overline{φ}}}_{P} ) ( {α}_{a 33} {v}_{a 31} + {α}_{a 11} ) , \\ \frac{{N}_{c} ( \overline{x} , {\overline{\overline{φ}}}_{P} )}{l {\overline{\overline{Φ}}}_{c}} = \frac{{E}_{a 11} {t}_{a} ( 1 - {v}_{c 13} {v}_{c 31} )}{2 {E}_{c 11} {t}_{c}} ( \frac{{e}^{- {\overline{λ}}_{3} \overline{x}} \overline{\overline{D}} ( {\overline{\overline{φ}}}_{P} )}{{\overline{λ}}_{3}} - \frac{{e}^{{\overline{λ}}_{3} \overline{x}} \overline{\overline{C}} ( {\overline{\overline{φ}}}_{P} )}{{\overline{λ}}_{3}} + \frac{{e}^{- {\overline{λ}}_{1} \hat{x}} \overline{\overline{B}} ( {\overline{\overline{φ}}}_{P} )}{{\overline{λ}}_{1}} - \frac{{e}^{{\overline{λ}}_{1} \overline{x}} \overline{\overline{A}} ( {\overline{\overline{φ}}}_{P} )}{{\overline{λ}}_{1}} ) + \frac{\overline{x} ( 1 - {v}_{c 13} {v}_{c 31} )}{{E}_{c 11} {t}_{c}} ( {\overline{\overline{φ}}}_{P} \frac{Θ}{{θ}_{P}} + \frac{{E}_{a 11} {t}_{a}}{2 \overline{γ}} ) + \overline{x} \frac{Θ}{{θ}_{Δ T}} ( 1 - {\overline{\overline{φ}}}_{P} ) ( {α}_{c 33} {v}_{c 31} + {α}_{c 11} ) . \qquad ( 22 )$$

### Model Information

TABLE 4
Assumed material properties in CFE and MBJFE solutions (moduli
in Gpa, expansion coeffs. in με · ° C.⁻¹)

| | | | AS4/3501-6 | |
|---|---|---|---|---|
| Material | Aluminum | Titanium | (0°) | FM300 |
| E₁₁ | 70 | 110 | 148 | 1.98 |
| E₂₂ | 70 | 110 | 10.6 | 1.98 |
| E₃₃ | 70 | 110 | 10.6 | 1.98 |
| G₁₂ | 26.3 | 41.4 | 5.61 | 0.71 |
| G₁₃ | 26.3 | 41.4 | 5.61 | 0.71 |
| G₂₃ | 26.3 | 41.4 | 3.17 | 0.71 |
| ν₁₂ | 0.33 | 0.33 | 0.30 | 0.40 |
| ν₁₃ | 0.33 | 0.33 | 0.30 | 0.40 |
| ν₂₃ | 0.33 | 0.33 | 0.59 | 0.40 |
| α₁₁ | 23 | 9 | −0.8 | 20 |
| α₂₂ | 23 | 9 | 29 | 20 |
| α₃₃ | 23 | 9 | 29 | 20 |

### System Parameters in Terms of Material Properties and Loads

The following variables are used in the text above in order to facilitate compact equations:

### Dimensionless System Parameters

TABLE 5
Dimensionless System Parameters

| Load Parameters | Material Parameters |
|---|---|
| ${\overline{φ}}_{P} = \frac{{θ}_{P} P}{Θ}$ | $\overline{β} = \frac{{θ}_{β}}{Θ}$ |
| ${\overline{φ}}_{T} = \frac{{θ}_{ΔT} ΔT}{Θ}$ | $\overline{γ} = \frac{{θ}_{γ}}{Θ}$ |

### Dimensionless Material Parameters

$${θ}_{β} = + \frac{{t}_{a}^{3}}{24 {l}^{2}} [ \frac{( {v}_{a 12} + {v}_{a 13} {v}_{a 32} )}{{E}_{a 11}} + \frac{( {v}_{a 21} + {v}_{a 23} {v}_{a 31} )}{{E}_{a 22}} ] - \frac{{t}_{a}^{2} {t}_{c}}{24 {l}^{2}} [ \frac{( {v}_{c 12} + {v}_{c 13} {v}_{c 32} )}{{E}_{c 11}} + \frac{( {v}_{c 21} + {v}_{c 23} {v}_{c 31} )}{{E}_{c 22}} ] + \frac{{t}_{a}^{2}}{4 {l}^{2} {E}_{a 11}} ( \frac{{t}_{b}}{1} ( {v}_{a 12} + {v}_{a 13} {v}_{a 32} ) + \frac{{t}_{c}}{2} ( {v}_{a 12} + {v}_{a 13} {v}_{a 32} ) ) + \frac{{t}_{a}^{2}}{4 {l}^{2} {E}_{a 22}} ( \frac{{t}_{b}}{1} ( {v}_{a 21} + {v}_{a 23} {v}_{a 31} ) + \frac{{t}_{c}}{2} ( {v}_{a 21} + {v}_{a 23} {v}_{a 31} ) ) - \frac{{t}_{a}^{2}}{8 {l}^{2}} [ \frac{{t}_{c}}{3 {G}_{c 11}} + \frac{{t}_{b}}{{G}_{b 11}} ] \\ {θ}_{γ} = \frac{{t}_{a}^{2}}{4 {E}_{c 11} {t}_{c}} ( 1 - {v}_{c 13} {v}_{c 31} ) + \frac{{t}_{a}}{2 {E}_{a 11}} ( 1 - {v}_{a 13} {v}_{a 31} ) \qquad ( 23 )$$

### Dimensionless Load Parameters

$${θ}_{Δ T} = \frac{{t}_{a}}{2 {E}_{a 11}} ( {α}_{a 11} - {α}_{c 11} + {α}_{a 33} {v}_{a 31} - {α}_{c 33} {v}_{a 31} - {α}_{c 33} {v}_{c 31} ) \\ {θ}_{P} = - \frac{{t}_{a}}{2 {t}_{c} {E}_{a 11} {E}_{c 11}} ( 1 - {v}_{c 13} {v}_{c 31} ) \qquad ( 24 )$$

### Dimensional System Parameter

$$Θ = + ( 1 - {v}_{a 23} {v}_{a 32} ) \frac{{t}_{a}^{3}}{8 {l}^{4} {E}_{a 22}} [ \frac{{t}_{a}^{2}}{30} + \frac{{t}_{a} {t}_{c}}{6} + \frac{{t}_{c}^{4}}{4} + \frac{{t}_{a} {t}_{b}}{3} + \frac{{t}_{a} {t}_{b}}{1} + \frac{{t}_{b}^{2}}{1} ] + ( 1 - {v}_{b 23} {v}_{b 32} ) \frac{{t}_{a}^{2} {t}_{b}}{4 {l}^{4} {E}_{b 22}} [ \frac{{t}_{c}^{2}}{4} + \frac{{t}_{b}^{2}}{3} + \frac{{t}_{b} {t}_{c}}{2} ] + ( 1 - {v}_{c 23} {v}_{c 32} ) \frac{{t}_{a}^{2} {t}_{c}^{3}}{80 {l}^{4} {E}_{c 22}} \qquad ( 25 )$$

### Intermediate Variables

$$\begin{matrix}{\overline{\overline{Φ}}}_{a} = \frac{{\overline{λ}}_{1} {\overline{λ}}_{3} {e}^{{\overline{λ}}_{3} + {\overline{λ}}_{1}}}{{\overline{\overline{Ξ}}}_{a}} , \\ {\overline{\overline{Φ}}}_{c} = \frac{{\overline{λ}}_{1} {\overline{λ}}_{3} {e}^{{\overline{λ}}_{3} + {\overline{λ}}_{1}}}{{\overline{\overline{Ξ}}}_{c}} , & ( 26 ) \\ {\overline{\overline{Ξ}}}_{a} = + {l}_{e} {\overline{λ}}_{1} ( 1 - {v}_{a 13} {v}_{a 31} ) ( {e}^{{\overline{λ}}_{3} + {\overline{λ}}_{1}} - {e}^{{\overline{λ}}_{1}} ) \overline{\overline{D}} ( {\overline{\overline{φ}}}_{P} ) + {l}_{e} {\overline{λ}}_{1} ( 1 - {v}_{a 13} {v}_{a 31} ) ( {e}^{2 {\overline{λ}}_{3} + {\overline{λ}}_{1}} - {e}^{{\overline{λ}}_{3} + {\overline{λ}}_{1}} ) \overline{\overline{C}} ( {\overline{\overline{φ}}}_{P} ) + {l}_{e} {\overline{λ}}_{3} ( 1 - {v}_{a 13} {v}_{a 31} ) ( {e}^{{\overline{λ}}_{3} + {\overline{λ}}_{1}} - {e}^{{\overline{λ}}_{3} + {\overline{λ}}_{1}} ) \overline{\overline{A}} ( {\overline{\overline{φ}}}_{P} ) - {l}_{e} {\overline{λ}}_{1} {\overline{λ}}_{3} {e}^{{\overline{λ}}_{3} + {\overline{λ}}_{1}} ( \frac{( 1 - {v}_{a 13} {v}_{a 31} )}{\overline{γ}} - \frac{Θ}{{θ}_{Δ T}} ( 1 - {\overline{\overline{φ}}}_{P} ) ( {α}_{a 11} + {α}_{a 33} {v}_{a 31} ) ) , \\ {\overline{\overline{Ξ}}}_{c} = - \frac{{E}_{a 11} {t}_{a}}{2 {E}_{c 11} {t}_{c}} {l}_{e} {\overline{λ}}_{1} ( 1 - {v}_{c 13} {v}_{c 31} ) ( {e}^{{\overline{λ}}_{1}} + {e}^{{\overline{λ}}_{3} + {\overline{λ}}_{1}} ) \overline{\overline{D}} ( {\overline{\overline{φ}}}_{P} ) - \frac{{E}_{a 11} {t}_{a}}{2 {E}_{c 11} {t}_{c}} {l}_{e} {\overline{λ}}_{1} ( 1 - {v}_{c 13} {v}_{c 31} ) ( {e}^{{\overline{λ}}_{1}} + {e}^{{\overline{λ}}_{3} + {\overline{λ}}_{1}} ) \overline{\overline{D}} ( {\overline{\overline{φ}}}_{P} ) - \frac{{E}_{a 11} {t}_{a}}{2 {E}_{c 11} {t}_{c}} {l}_{e} {\overline{λ}}_{3} ( 1 - {v}_{c 13} {v}_{c 31} ) ( {e}^{{\overline{λ}}_{3} + 2 {\overline{λ}}_{1}} - {e}^{{\overline{λ}}_{3} + {\overline{λ}}_{1}} ) \overline{\overline{A}} ( {\overline{\overline{φ}}}_{P} ) + \frac{{l}_{e} {\overline{λ}}_{1} {\overline{λ}}_{3} {e}^{{\overline{λ}}_{3} + {\overline{λ}}_{1}}}{2 {E}_{c 11} {t}_{c}} ( \frac{Θ}{{θ}_{Δ T}} ( 1 - {\overline{\overline{φ}}}_{P} ) ( {α}_{c 11} + {α}_{c 33} {v}_{c 31} ) ) . & ( 27 )\end{matrix}$$

### μ Parameters for the Basis Coefficients

The μ values of Eq. (10) are given by:

$${μ}_{{A}_{T}} = \frac{{\overline{λ}}_{3} ( {e}^{{\overline{λ}}_{3}} - 1 )}{\overline{γ}} \\ {μ}_{{B}_{T}} = \frac{{e}^{{\overline{λ}}_{1}} {\overline{λ}}_{3} ( {e}^{{\overline{λ}}_{3}} - 1 )}{\overline{γ}} \\ {μ}_{{C}_{T}} = - \frac{{\overline{λ}}_{1} ( {e}^{{\overline{λ}}_{1}} - 1 )}{\overline{γ}} \\ {μ}_{{D}_{T}} = - \frac{{\overline{λ}}_{1} ( {e}^{{\overline{λ}}_{1}} - 1 ) {e}^{{\overline{λ}}_{3}}}{\overline{γ}} \\ {μ}_{{A}_{P}} = - ( {\overline{λ}}_{3} {e}^{2 {\overline{λ}}_{3} + {\overline{λ}}_{1}} - {\overline{λ}}_{1} {e}^{2 {\overline{λ}}_{3} + {\overline{λ}}_{1}} + 2 {\overline{λ}}_{1} {e}^{{\overline{λ}}_{3}} - {e}^{{\overline{λ}}_{1}} {\overline{λ}}_{3} - {\overline{λ}}_{1} {e}^{{\overline{λ}}_{1}} ) \\ {μ}_{{B}_{P}} = {e}^{{\overline{λ}}_{1}} ( - 2 {\overline{λ}}_{1} {e}^{{\overline{λ}}_{3} + {\overline{λ}}_{1}} + {\overline{λ}}_{3} {e}^{2 {\overline{λ}}_{3}} + {\overline{λ}}_{1} {e}^{2 {\overline{λ}}_{3}} - {\overline{λ}}_{3} + {\overline{λ}}_{1} ) \\ {μ}_{{C}_{P}} = \frac{{\overline{λ}}_{1} ( {\overline{λ}}_{3} {e}^{{\overline{λ}}_{3} + 2 {\overline{λ}}_{1}} - {\overline{λ}}_{1} {e}^{{\overline{λ}}_{3} + 2 {\overline{λ}}_{1}} + {\overline{λ}}_{3} {e}^{{\overline{λ}}_{3}} + {\overline{λ}}_{1} {e}^{{\overline{λ}}_{3}} - 2 {e}^{{\tilde{λ}}_{1}} {\overline{λ}}_{3} )}{{\overline{λ}}_{3}} \\ {μ}_{{D}_{P}} = \frac{{\overline{λ}}_{1} {e}^{{\overline{λ}}_{3}} ( 2 {\overline{λ}}_{3} {e}^{{\overline{λ}}_{3} + {\overline{λ}}_{1}} - {e}^{2 {\overline{λ}}_{1}} {\overline{λ}}_{3} - {\overline{λ}}_{3} - {\overline{λ}}_{1} {e}^{2 {\overline{λ}}_{1}} + {\overline{λ}}_{1} )}{{\overline{λ}}_{3}} \\ {μ}_{1} = {\overline{λ}}_{3} {e}^{{\overline{λ}}_{3} + {\overline{λ}}_{1}} - {\overline{λ}}_{1} {e}^{{\overline{λ}}_{3} + {\overline{λ}}_{1}} + {\overline{λ}}_{3} {e}^{{\overline{λ}}_{3}} + {\overline{λ}}_{1} {e}^{{\overline{λ}}_{3}} - {e}^{{\overline{λ}}_{1}} {\overline{λ}}_{3} - {\overline{λ}}_{3} - {\overline{λ}}_{1} {e}^{{\overline{λ}}_{1}} + {\overline{λ}}_{1} \\ {μ}_{2} = {\overline{λ}}_{3} {e}^{{\overline{λ}}_{3} + {\overline{λ}}_{1}} - {\overline{λ}}_{1} {e}^{{\overline{λ}}_{3} + {\overline{λ}}_{1}} - {\overline{λ}}_{3} {e}^{{\overline{λ}}_{3}} - {\overline{λ}}_{1} {e}^{{\overline{λ}}_{3}} + {e}^{{\overline{λ}}_{1}} {\overline{λ}}_{3} - {\overline{λ}}_{3} + {\overline{λ}}_{1} {e}^{{\overline{λ}}_{1}} + {\overline{λ}}_{1} \\ {μ}_{3} = \frac{{E}_{c 11} {\overline{λ}}_{3} {t}_{b}^{3} {t}_{c} ( {v}_{b 23} {v}_{b 32} - 1 )}{3 {E}_{b 22} {l}^{4} ( {v}_{c 13} {v}_{c 31} - 1 )} \qquad ( 28 )$$

### Nomenclature

lₑ Length of the lap sub-element, m
t_{κ} Material thicknesses of component κ, m
x,y Cartesian coordinates measured from the lower left corner of the adhesive, m
σ_{κ11(x)} Longitudinal stress in component κ, Pa
σ_{κ22(x,y)} Transverse stress in component κ, Pa
τ_{η12(x)} Shear stress in component κ, Pa
\hat{σ}_{η11(x)} Longitudinal virtual stress in component κ
\hat{σ}_{κ22}(x,y) Transverse virtual stress in component κ
τ_{κ12(x)} Shear virtual stress in component κ
E_{κ11} Orthotropic engineering moduli of component κ, Pa
G_{bij} Orthotropic shear modulii of the adhesive, Pa
α_{κii} Orthotropic thermal expansion coefficient of component κ; ° C.⁻¹
ν_{κij} Poisson's ratios of component κ
P Mechanical load applied to the joint, per unit depth, N m⁻¹
P₁,P₂ Element internal mechanical load DOFs, per unit depth, N m⁻¹
ΔT Temperature change from a reference temperature, ° C.
x̅ Normalized coordinate x/lₑ measured from the left edge of the joint
β̅, γ̅, λ̅₁, λ̅₃ Dimensionless system parameters
φ̅_{P} Dimensionless mechanical load parameter
φ̅_{T} Dimensionless thermal load parameter
φ̅ₜₒₜₐₗ Dimensionless total load parameter
φ̅_{P} Dimensionless mechanical load fraction
A̅, B̅, C̅, D̅ Dimensionless basis coefficients
\overline{ \overline{Φ}}ₐ, \overline{ \overline{Φ}}_{c} Intermediate variables Ξ̅_{z}, Ξ̅_{c} Intermediate variables
q₁,q₂,q₃,q₄ Nodal displacement degrees of freedom
qₑ Subelement extension degree of freedom
Nₐ, N_{c} Element shape functions
Bₐ, B_{c} Element shape function derivatives

### Subscripts

[ ] the or operator, i.e., [12] is 1 or 2 (no sum)
κ κ=[abcp] (no sum) Subscript representing central adherend (a), adhesive (b), outer adherend (c), and end post (p) respectively
ii i=[123] (no sum)
ii i,j=[123] where i≠j (no sum)

### APPENDIX B

### Analytically Derived Stress Field in a Double Lap Joint Including Thermal Expansion

A Model which Assumes the Adhesive Carries Shear Stress Only

The double lap joint 8 is schematically shown in FIG. 1. Here, a symmetric geometry is assumed, and two solutions will be proposed. The first solution will assume that the stress field varies only along the direction of loading. The adherends are assumed to carry longitudinal normal stress only, and the adhesive is assumed to carry shear stress only. Due to symmetry, the bending moments present in the joint are assumed to be negligible. Therefore, bending of adherends is not included. Under these assumptions, the stress field is a function of x only. Thermal expansion is assumed to be linear with temperature. Plasticity, creep, and other non-linearities of the constituents are ignored, though it is likely that they could be significant. Under these assumptions and assuming plane strain deformation, the constitutive equations for material κ are governed by:

$$\{ \begin{matrix}{ε}_{κ11} ( x ) \\ {ε}_{κ22} ( x ) \\ {γ}_{κ12} ( x )\end{matrix} \} = [ \begin{matrix}\frac{1 - {v}_{κ13} {v}_{κ31}}{{E}_{κ11}} & - \frac{{v}_{κ23} {v}_{κ31} + {v}_{κ21}}{{E}_{κ22}} & 0 \\ - \frac{{v}_{κ13} {v}_{κ32} + {v}_{κ12}}{{E}_{κ11}} & \frac{1 - {v}_{κ23} {v}_{κ32}}{{E}_{κ22}} & 0 \\ 0 & 0 & \frac{1}{{G}_{κ12}}\end{matrix} ] \{ \begin{matrix}{σ}_{κ11} ( x ) \\ {σ}_{κ22} ( x ) \\ {τ}_{κ12} ( x )\end{matrix} \} + [ \begin{matrix}{α}_{κ33} {v}_{κ31} + {α}_{κ11} \\ {α}_{κ33} {v}_{κ32} + {α}_{κ22} \\ 0\end{matrix} ] Δ T \qquad ( 1 )$$

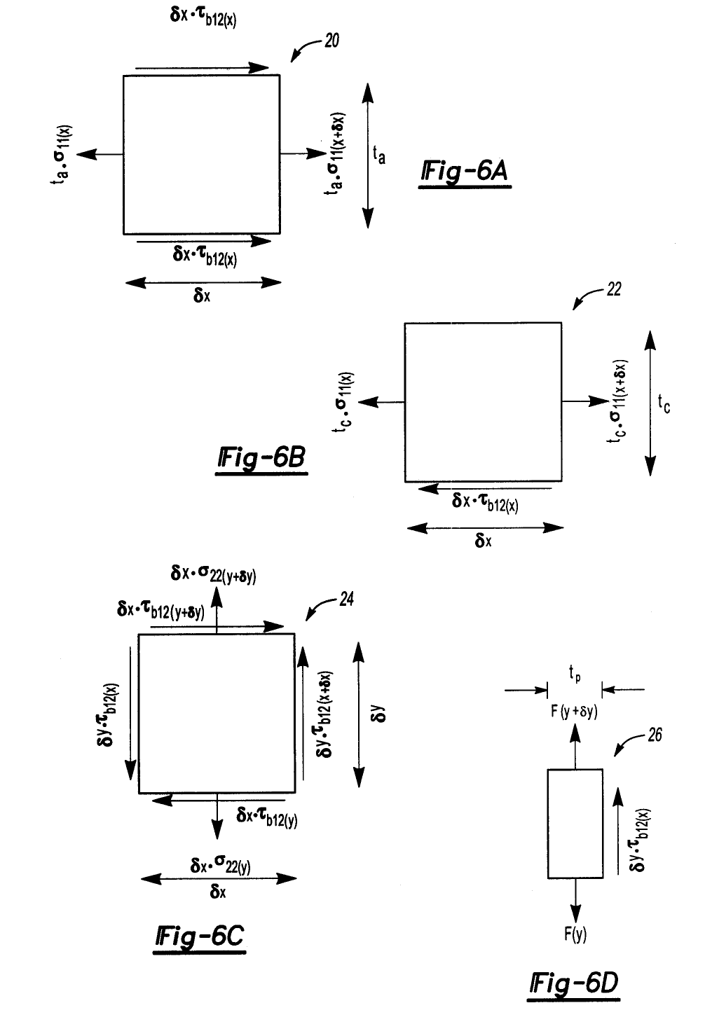

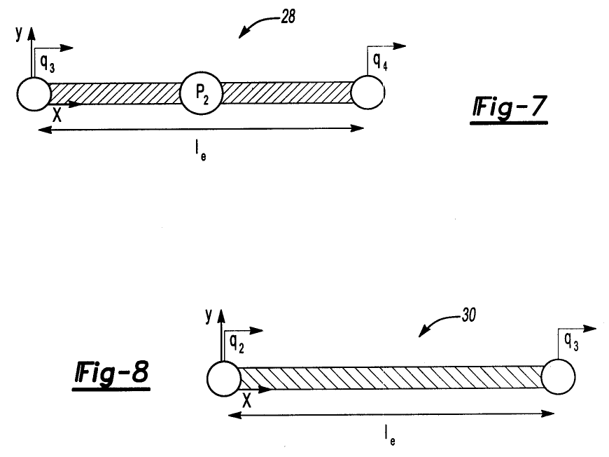

A plane stress assumption could be substituted by setting all out-of-plane Poisson terms to zero (ν_{κ13}=ν_{κ31}=0). The central adherend 10 shown in FIG. 1 is referred to as material a. An equilibrium element 20 for the central adherend 10 is shown in FIG. 6A. The outer adherend 12 shown in FIG. 1 is referred to as material c. An equilibrium element 22 for the outer adherend 12 is shown in FIG. 6B. In these two areas, x-equilibrium requires the following:

$$\frac{\partial {σ}_{a 11 ( x )}}{\partial x} = - \frac{2}{{t}_{a}} {τ}_{b 12 ( x )} , \\ \frac{\partial {σ}_{c 11 ( x )}}{\partial x} = - \frac{1}{{t}_{c}} {τ}_{b 12 ( x )} , \qquad ( 2 )$$

where x is measured from the left edge of the adhesive. Solving Eqs. (2) for τ_{b12(x)} and equating leads to:

$${t}_{c} \frac{\partial {σ}_{c 11 ( x )}}{\partial x} = \frac{{t}_{a}}{2} \frac{\partial {σ}_{a 11 ( x )}}{\partial x} . \qquad ( 3 )$$

The natural boundary conditions at the edge of adherend a are:

$${σ}_{a 11 ( 0 )} = 0 , \\ {σ}_{a 11 ( l )} = \frac{2 P}{{t}_{a}} , \qquad ( 4 )$$

which are the longitudinal normal stresses in the central adherend at the edges of the joint. Combining the above equation leads to the following relationship between stresses in the central and outer adherends:

$${σ}_{c 11 ( x )} = \frac{P}{{t}_{c}} - \frac{{t}_{a}}{2 {t}_{c}} {σ}_{a 11 ( x )} . \qquad ( 5 )$$

Since the shear stress is assumed to be constant through the thickness of the adhesive, the shear stress in the adhesive is determined by Eqs. (2) and the solution to Eq. (5). Eqs. (2)-(5) can be combined using the principle of virtual work to solve for the central adherend stress. This leads to a differential equation in the following form:

$$\frac{{\partial }^{2} {σ}_{a 11 ( x )}}{\partial {x}^{2}} + {ω}^{2} {σ}_{a 11} + {ψ}_{T} + {ψ}_{P} = 0. \qquad ( 6 )$$

In Eq. (6), it is worth noting that the thermal and mechanical loads enter the differential equation in the form of system parameters Ψ_{T} and Ψ_{P}. Before stating the values of the system parameters ω², Ψ_{T}, and Ψ_{P}, it is reasonable to non-dimensionalize the solution to Eq. (6), therefore the following substitutions are made:

$${\overline{ψ}}_{T} = {ψ}_{T} \frac{{l}^{2}}{{E}_{a 11}} , \\ {\overline{ψ}}_{P} = {ψ}_{P} \frac{{l}^{2}}{{E}_{a 11}} , \\ \overline{x} = \frac{x}{l} , \\ \overline{ω} = l ω , \\ {\overline{τ}}_{b 12 ( \overline{x} )} = \frac{{τ}_{b 12 ( l \overline{x} )}}{{E}_{a 11}} , \\ {\overline{σ}}_{a 11 ( \overline{x} )} = \frac{{σ}_{a 11 ( l \overline{x} )}}{{E}_{a 11}} . \qquad ( 7 )$$

In Eq. (7), the non-dimensional axial stress σ̅_{a11( x̅)} could easily be confused for the axial strain εₐ₁₁, however this is not the case since the stress field is not uniaxial. In analytical models offered previously, the average shear stress τ_{b12} have has been chosen as the normalizing factor. However, since a thermal load without an externally applied mechanical load results in a zero average shear stress, the modulus of the central adherend Eₐ₁₁ is used for the normalization. Unfortunately, this choice loses the “stress concentration factor” associated with the average shear normalization, however it is necessary to avoid a singular result for thermal loads. Upon substitution, Eq. (6) becomes:

$$\frac{{\partial }^{2} {\overline{σ}}_{a 11}}{\partial {\overline{x}}^{2}} + {\overline{ω}}^{2} {\overline{σ}}_{a 11} + {\overline{ψ}}_{T} + {\overline{ψ}}_{P} = 0 , \qquad ( 8 )$$

which is a non-dimensional form of the governing equation. The parameters ω̅², Ψ̅_{T}, and Ψ̅_{P} are given by:

$${\overline{ω}}^{2} = \frac{2 {G}_{b 12} {l}^{2}}{{t}_{b}} [ \frac{( {v}_{c 13} {v}_{c 31} - 1 )}{{E}_{c 11} {t}_{c}} + \frac{2 ( {v}_{a 13} {v}_{a 31} - 1 )}{{E}_{a 11} {t}_{a}} ] , \\ {\overline{ψ}}_{T} = [ \frac{4 {G}_{b 12} {l}^{2} ( {α}_{c 33} {v}_{c 31} - {α}_{a 33} {v}_{a 31} + {α}_{c 11} - {α}_{a 11} )}{{E}_{a 11} {t}_{a} {t}_{b}} ] Δ T , \\ {\overline{ψ}}_{P} = - [ \frac{4 {G}_{b 12} {l}^{2} ( {v}_{c 13} {v}_{c 31} - 1 )}{{E}_{a 11} {E}_{c 11} {t}_{a} {t}_{b} {t}_{c}} ] P . \qquad ( 9 )$$

It is worth noting that Eq. (9) contains non-dimensional parameters for both thermal and mechanical loading. Also, thermal expansion of the adhesive is not a factor in this model, since the adhesive is assumed to carry no longitudinal normal stress.

The solution to Eq. (6) takes the form:

$${\overline{σ}}_{a 11 ( \overline{x} )} = \overline{a} sin ( \overline{ω x} ) + \overline{b} cos ( \overline{ω x} ) - \frac{{\overline{ψ}}_{T} + {\overline{ψ}}_{P}}{{\overline{ω}}^{2}} , \qquad ( 10 )$$

and possesses the following boundary conditions for longitudinal normal stress:

$${\overline{σ}}_{a 11} ( 0 ) = 0 , \\ {\overline{σ}}_{a 11} ( 1 ) = \frac{2 P}{{t}_{a} {E}_{a 11}} . \qquad ( 11 )$$

Application of the boundary conditions leads to the following values for the coefficients ā, b̅:

$$\overline{a} = [ \frac{{E}_{c 11} {t}_{b} {t}_{c}}{2 {G}_{b 12} {l}^{2} sin \overline{ω} ( {v}_{c 13} {v}_{c 31} - 1 )} + \frac{cos \overline{ω} - 1}{{\overline{ω}}^{2} sin \overline{ω}} ] {\overline{ψ}}_{P} - \frac{( cos \overline{ω} - 1 )}{{\overline{ω}}^{2} sin \overline{ω}} {\overline{ψ}}_{T} , \\ \overline{b} = \frac{{\overline{ψ}}_{T} + {\overline{ψ}}_{P}}{{\overline{ω}}^{2}} \qquad ( 12 )$$

and the solution is completed.

The SO solution presented in this section minimizes solution complexity. As a result, it lacks certain features. It does not offer a traction free adhesive edge, nor does it quantify the peel stress. Despite these shortcomings, the model is useful. It provides an orthotropic solution which includes consideration of thermal expansion. Also, important non-dimensional parameters have been identified in Eq. (9). These parameters dictate the joint stress distribution, and can be used as a first order analysis tool in the design of bonded double lap joints. Further, the SO solution provides the foundation for a formulation posed in the next section, the solution of which provides a zero traction at the adhesive edge.

A Model which Assumes the Adhesive Carries Shear and Peel Stress

The second solution presented is the SP extension to the above analysis. In this case, the adhesive is no longer confined to carry only shear stress. Instead, it is now assumed to carry shear and peel stresses, as shown in the element 24 of FIG. 6C. The adherends are assumed to be stiff, and carry only normal stresses as before. For convenience, a fictitious structural element 26, which is included in FIG. 1, referred to as an “end post” is located at the edge of the adhesive, and is assumed to be capable of transferring any shear stress at the edge towards the adherends. In making this assumption, the traction boundary condition is satisfied a priori. The end post element 26, which is also shown in FIG. 6D, will be carried through the calculations and then eliminated at the end to restore the correct geometry.

The stress fields in the adherends are as described in the SO solution, with the exception of the peel stress in the adhesive layer. The x-equilibrium equations provided above still hold, however, y-equilibrium in the adhesive is now included in the analysis.

Force equilibrium in the y direction of the adhesive requires the following relation:

$$\frac{\partial {σ}_{b 22 ( x , y )}}{\partial y} = - \frac{\partial {τ}_{b 12 ( x )}}{\partial x} , \qquad ( 13 )$$

where σ_{b22(y)} is assumed to be a linear function of y, which is the lowest order assumption that satisfies the equilibrium requirement.

σ_{b22(y)}c₀+c₁y. (14)

The peel stress at the adhesive interface is assumed to be zero, σ_{b22(t}_{_{b)}}=0, therefore:

$${σ}_{b 22 ( y )} = {c}_{0} ( 1 - \frac{y}{{t}_{b}} ) . \qquad ( 15 )$$

Combining Eq. (13) and Eq. (15) leads to:

$${σ}_{b 22 ( x , y )} = \frac{{t}_{a}}{2} ( y - {t}_{b} ) \frac{{\partial }^{2} {σ}_{a 11 ( x )}}{\partial {x}^{2}} . \qquad ( 16 )$$

Force equilibrium in the y direction on the left end post 26, as shown in FIG. 6D, requires the following relation:

$$\frac{\partial {F}_{\{ v , x = 0 \}}}{\partial y} = - {τ}_{b 12 ( 0 )} , \qquad ( 17 )$$

where the force carried by the end post is also assumed to be a linear function of y:

F_{(y,x=0)}=d₀+d₁y. (18)

Combining Eq. (18) with Eqs. (2) leads to:

$${F}_{( y , x = 0 )} = \frac{{t}_{a}}{2} \frac{\partial {σ}_{a 11 ( x = 0 )}}{\partial x} y + {d}_{0} . \qquad ( 19 )$$

Using similar arguments for the right end post 26, and applying the equilibrium requirement that the total end post force vanishes on each side, the end post governing equations are given by Eqs. (20).

$${F}_{( y , x = 0 )} = \frac{{t}_{a}}{2} \frac{\partial {σ}_{a 11 ( x = 0 )}}{\partial x} ( y - \frac{{t}_{b}}{2} ) \\ {F}_{( y , x = l )} = - \frac{{t}_{a}}{2} \frac{\partial {σ}_{a 11 ( x = l )}}{\partial x} ( y - \frac{{t}_{b}}{2} ) \qquad ( 20 )$$

With the equilibrium requirements now complete, application of the principal of virtual forces leads to a differential equation of the following form:

$$\frac{{\partial }^{4} {σ}_{a 11 ( x )}}{\partial {x}^{4}} + β \frac{{\partial }^{2} {σ}_{a 11 ( x )}}{\partial {x}^{2}} + {γσ}_{a 11 ( x )} + {φ}_{T} + {φ}_{P} = 0. \qquad ( 21 )$$

As was the case in the SO solution, here in Eq. (21) the thermal and mechanical loads enter the differential equation in the form of system parameters φ_{T} and φ_{P}. Without explicit statement of the parameters, nondimensionalizing substitutions can be made:

$$\overline{x} = \frac{x}{l} , \\ \overline{β} = {l}^{2} β , \\ \overline{γ} = {l}^{4} γ , \\ {\overline{σ}}_{a 11 ( \overline{x} )} = \frac{{σ}_{a 11 ( l \overline{x} )}}{{E}_{a 11}} , \\ {\overline{τ}}_{b 12 ( \overline{x} )} = \frac{{τ}_{b 12 ( l \overline{x} )}}{{E}_{a 11}} , \\ {\overline{φ}}_{T} = {φ}_{T} \frac{{l}^{4}}{{E}_{a 11}} , \\ {\overline{φ}}_{P} = {φ}_{P} \frac{{l}^{4}}{{E}_{a 11}} . \qquad ( 22 )$$

The solution of Eqs. (2), (16), (20) as well as the non-dimensionalizing substitutions given in Eqs. (22) lead to the following differential equation for the normalized stress in the central adherend:

$$\frac{{\partial }^{4} {\overline{σ}}_{a 11}}{\partial {\overline{x}}^{4}} + \overline{β} \frac{{\partial }^{2} {\overline{σ}}_{a 11}}{\partial {\overline{x}}^{2}} + \overline{γ} {\overline{σ}}_{a 11} + {\overline{φ}}_{T} + {\overline{φ}}_{P} = 0 , \qquad ( 23 )$$

where the dimensionless system parameters are given by:

$$\overline{β} = \frac{3 {E}_{b 22} {l}^{2}}{2 {G}_{b 12} {t}_{b}^{2} ( {v}_{b 23} {v}_{b 32} - 1 )} , \\ \overline{γ} = \frac{3 {E}_{b 22} {l}^{4}}{{t}_{b}^{3} ( {v}_{b 23} {v}_{b 32} - 1 )} [ \frac{( {v}_{c 13} {v}_{c 31} - 1 )}{{E}_{c 11} {t}_{c}} + \frac{2 ( {v}_{a 13} {v}_{a 31} - 1 )}{{E}_{a 11} {t}_{a}} ] , \\ {\overline{φ}}_{T} = [ \frac{6 {E}_{b 22} {l}^{4} ( {α}_{c 33} {v}_{c 31} - {α}_{a 33} {v}_{a 31} + {α}_{c 11} - {α}_{a 11} )}{{E}_{a 11} {t}_{a} {t}_{b}^{3} ( {v}_{b 23} {v}_{b 32} - 1 )} ] Δ T , \\ {\overline{φ}}_{P} = - [ \frac{6 {E}_{b 22} {l}^{4} ( {v}_{c 13} {v}_{c 31} - 1 )}{{E}_{a 11} {E}_{c 11} {t}_{a} {t}_{b}^{3} {t}_{c} ( {v}_{b 23} {v}_{b 32} - 1 )} ] P . \qquad ( 24 )$$

The solution takes the following form:

$${\overline{σ}}_{a 11} ( \tilde{x} ) = \overline{A} {e}^{{\overline{λ}}_{1} \tilde{x}} + \overline{B} {e}^{- {\overline{λ}}_{1} \tilde{x}} + \overline{C} {e}^{{\overline{λ}}_{3} \tilde{x}} + \overline{D} {e}^{- {\overline{λ}}_{3} \tilde{x}} - \frac{{\overline{φ}}_{T}}{γ} - \frac{{\overline{φ}}_{P}}{γ} . \qquad ( 25 )$$

The bi-quadratic Eq. (25) has two dimensionless system parameters λ̅₁ and λ̅₃ given by Eq. (26) and presented in terms of the orthotropic material properties in the “Definition of the Solution Parameters.”

$${\overline{λ}}_{[ 13 ]}^{2} = \frac{- \overline{β} \pm \sqrt{{\overline{β}}^{2} - 4 \overline{γ}}}{2} . \qquad ( 26 )$$

The appearance of β̅ and γ̅ in λ̅_{[13]}², which in turn governs the axial stress distribution along the adherend and therefore the shear stress distribution in the adhesive (through Eqs. (13) and (16)), clearly show the relative importance of the adhesive and adherend mechanical properties and the joint geometry. Similarly, φ̅_{T} and φ̅_{P} are two load parameters that are expressed through a combination of adhesive and adherend thermal and mechanical properties, loading, and joint geometry.

The coefficients Ā, B̅, C̅, and D̅ in Eq. (25) are determined by application of the boundary conditions, presented in full form in boundary conditions for the SP solution and in reduced form in Eqs. (27). These boundary conditions represent axial normal stress and shear stress at the ends of the central adherend 10. The reduced form is achieved by allowing the end posts 26 to approach zero thickness (taking the limit as tₚ→0). This procedure has the direct effect of forcing the shear stress at the post locations to zero, which results in a traction free surface at the adhesive edge.

$$\overline{D} + \overline{C} + \overline{B} + \overline{A} - \frac{{\overline{φ}}_{T} + {\overline{φ}}_{P}}{\overline{γ}} = 0 \\ {e}^{- {\overline{λ}}_{3}} \overline{D} + {e}^{{\overline{λ}}_{3}} \overline{C} + {e}^{- {\overline{λ}}_{1}} \overline{B} + {e}^{{\overline{λ}}_{1}} \overline{A} - \frac{{\overline{φ}}_{T} + {\overline{φ}}_{P}}{\overline{γ}} - \frac{2 P}{{E}_{a 11} {t}_{a}} = 0 \\ - {\overline{λ}}_{3} \overline{D} + {\overline{λ}}_{3} \overline{C} - {\overline{λ}}_{1} \overline{B} + {\overline{λ}}_{1} \overline{A} = 0 \\ - {\overline{λ}}_{3} {e}^{- {\overline{λ}}_{3}} \overline{D} + {\overline{λ}}_{3} {e}^{{\overline{λ}}_{3}} \overline{C} - {\overline{λ}}_{1} {e}^{- {\overline{λ}}_{1}} \overline{B} + {\overline{λ}}_{1} {e}^{{\overline{λ}}_{1}} \overline{A} = 0 \qquad ( 27 )$$

The solution of Eqs. (27) for Ā, B̅, C̅, and D̅ requires lengthy combinations of the system parameters. They are presented in a compact form in Eqs. (28), where certain repeating values have been represented as a series of multipliers μ. The values of these μ parameters are presented in the “Definition of the Solution Parameters.” With the presentation of Eqs. (28), the SP solution is now completed.

$$\overline{A} = \frac{{μ}_{{A}_{T}} {\overline{φ}}_{T} + ( {μ}_{{A}_{T}} + {μ}_{2} {μ}_{3} {μ}_{{A}_{P}} ) {\overline{φ}}_{P}}{{μ}_{1}} \\ \overline{B} = \frac{{μ}_{{B}_{T}} {\overline{φ}}_{T} + ( {μ}_{{B}_{T}} + {μ}_{2} {μ}_{3} {μ}_{{B}_{P}} ) {\overline{φ}}_{P}}{{μ}_{1}} \\ \overline{C} = \frac{{μ}_{{C}_{T}} {\overline{φ}}_{T} + ( {μ}_{{C}_{T}} + {μ}_{2} {μ}_{3} {μ}_{{C}_{P}} ) {\overline{φ}}_{P}}{{μ}_{1}} \\ \overline{D} = \frac{{μ}_{{D}_{T}} {\overline{φ}}_{T} + ( {μ}_{{D}_{T}} + {μ}_{2} {μ}_{3} {μ}_{{D}_{P}} ) {\overline{φ}}_{P}}{{μ}_{1}} \qquad ( 28 )$$

The SP solution presented above overcomes some of the effects previously ignored in bonded joint analysis. For example, it is an orthotropic thermomechanical solution which ensures that the shear stress at the traction free edge is zero. It does so with the minimal required complexity of a fourth order governing differential equation.

The analysis is an elastic solution, and as a result neglects the effect of adhesive and adherend plasticity, if any, on the joint. The inclusion of plasticity effects are best treated through a numerical solution.

### A Dimensionless Ratio of Thermal and Mechanical Loading Factors

Using the non-dimensional loading parameters defined in Eqs. (9) and (24), a dimensionless load ratio ( φ̅_{aR}) and total load ( φ̅ₜₒₜₐₗ) can be defined.

$${\overline{φ}}_{aR} = \frac{{\overline{φ}}_{T}}{{\overline{φ}}_{P}} = - \frac{{E}_{c 11} {t}_{c} ( {α}_{c 33} {v}_{c 31} - {α}_{a 33} {v}_{a 31} + {α}_{c 11} - {α}_{a 11} ) Δ T}{( {v}_{c 13} {v}_{c 31} - 1 ) P} \\ {\overline{φ}}_{total} = {\overline{φ}}_{P} + {\overline{φ}}_{T} \qquad ( 29 )$$

The ratio φ̅_{aR} is a measure of the relative importance of allowable thermal and mechanical loads. The importance of the load ratio φ̅_{[ac]R} must not be underestimated. When | φ̅_{[ac]R}|<<1, mechanical stress dominates the stress field in the adherend. Conversely, when | φ̅_{[ac]}>>1, the thermally induced stress field is dominant. Finally, when | φ̅_{[ac]R}|≈1, thermal and mechanical loads are both significant to the total stress field. Using φ̅_{aR} as a guide, it is easy to show that some common joints, such as aluminum to carbon fiber reinforced polymer matrix composite, can be dominated by thermal loading when a large Δ_{T} is present. It is significant that the dimensionless load ratio is the same whether the SO or the SP is used to derive it, as it is therefore independent of the adhesive stress field assumption.

The stress field that leads to the dimensionless number given in Eqs.
is based on the stress in the central adherend σₐ₁₁( x̅). Using Eq. (5) and similarly collecting terms into dimensionless loads, a conjugate dimensionless load ratio can be written for the stress field in the outer adherend σ̅_{c11}( x̅):

$${\overline{φ}}_{cR} = \frac{{E}_{a 11} {t}_{a} ( {α}_{c 33} {v}_{c 31} - {α}_{a 33} {v}_{a 31} + {α}_{c 11} - {α}_{a 11} ) Δ T}{2 ( {v}_{a 13} {v}_{a 31} - 1 ) P} . \qquad ( 30 )$$

Examining Eqs. (29) and (30), it is apparent that the dimensionless load ratio in one adherend depends largely on the stiffness of the other adherend.

With the dimensionless load ratio in mind, a load-based normalization can be defined by rewriting the axial stress as:

$${\overline{\overline{σ}}}_{a 11} = \frac{{\overline{σ}}_{a 11}}{{\overline{φ}}_{total}} , \qquad ( 31 )$$

or, more intuitively:

σ̅_{a11( x̅)}= σ̅_{a11( φ̅p,x)}· φ̅_{total.} (32)

This second normalization can be propagated throughout the solution so that the SO and SP solutions are written as:

$${\overline{\overline{σ}}}_{a 11 ( \overline{x} )} = \overline{\overline{a}} sin ( \overline{ω} \overline{x} ) + \overline{\overline{b}} cos ( \overline{ω} \overline{x} ) - \frac{1}{{\overline{ω}}^{2}} , \\ {\overline{\overline{σ}}}_{a 11 ( \overline{x} )} = \overline{\overline{A}} {e}^{{\overline{λ}}_{1} \overline{x}} + \overline{\overline{B}} {e}^{- {\overline{λ}}_{1} \overline{x}} + \overline{\overline{C}} {e}^{{\overline{λ}}_{3} \overline{x}} + \overline{\overline{D}} {e}^{- {\overline{λ}}_{3} \overline{x}} - \frac{1}{γ} . \qquad ( 33 )$$

Doing so requires that the boundary conditions be rewritten as:

$${\overline{\overline{σ}}}_{a 11} ( 0 ) = 0 , \\ {\overline{\overline{σ}}}_{a 11} ( 1 ) - \frac{2 P}{{t}_{a} {E}_{a 11} {\overline{φ}}_{total}} = 0 , \qquad ( 34 )$$

for the SO solution, and for the SP solution as:

$$\overline{\overline{D}} + \overline{\overline{C}} + \overline{\overline{B}} + \overline{\overline{A}} - \frac{1}{\overline{y}} = 0 , \\ {e}^{- {\overline{λ}}_{3}} \overline{\overline{D}} + {e}^{{\overline{λ}}_{3}} \overline{\overline{C}} + {e}^{- {\overline{λ}}_{1}} \overline{\overline{B}} + {e}^{{\overline{λ}}_{1}} \overline{\overline{A}} - \frac{1}{\overline{γ}} - \frac{2 P}{{E}_{a 11} {t}_{a} {\overline{φ}}_{total}} = 0 , \\ - {\overline{λ}}_{3} \overline{\overline{D}} + {\overline{λ}}_{3} \overline{\overline{C}} - {\overline{λ}}_{1} \overline{\overline{B}} + {\overline{λ}}_{1} \overline{\overline{A}} = 0 , \\ - {\overline{λ}}_{3} {e}^{- {\overline{λ}}_{3}} \overline{\overline{D}} + {\overline{λ}}_{3} {e}^{{\overline{λ}}_{3}} \overline{\overline{C}} - {\overline{λ}}_{1} {e}^{- {\overline{λ}}_{1}} \overline{\overline{B}} + {\overline{λ}}_{1} {e}^{{\overline{λ}}_{1}} \overline{\overline{A}} = 0. \qquad ( 35 )$$

Using the load ratio φ̅_{aR}, we can split the coefficients into linear equations of the mechanical fraction of the load. Defining the mechanical load fraction as:

$${\overline{\overline{φ}}}_{P} = \frac{{\overline{φ}}_{P}}{{\overline{φ}}_{total}} = {( 1 + {\overline{φ}}_{aR} )}^{- 1} , \qquad ( 36 )$$

the coefficients a̅ and b̅ from Eqs. (10) for a load normalized solution can be written as:

$$\overline{\overline{a}} = - \frac{{E}_{c 11} {t}_{b} {t}_{c}}{2 {G}_{b 12} {l}^{2} sin \overline{ω} ( {v}_{c 13} {v}_{c 31} - 1 )} {\overline{\overline{φ}}}_{P} - \frac{cos \overline{ω} - 1}{{\overline{ω}}^{2} sin \overline{ω}} , \\ \overline{\overline{b}} = \frac{1}{{\overline{ω}}^{2}} . \qquad ( 37 )$$

Similarly, the A̅, B̅, C̅, and D̅ coefficients can be written as:

$$\overline{\overline{A}} = \frac{{μ}_{3} {μ}_{{A}_{P}}}{{μ}_{1} {μ}_{2}} {\overline{\overline{φ}}}_{P} + \frac{{μ}_{{A}_{T}}}{{μ}_{1}} , \\ \overline{\overline{B}} = \frac{{μ}_{3} {μ}_{{B}_{P}}}{{μ}_{1} {μ}_{2}} {\overline{\overline{φ}}}_{P} + \frac{{μ}_{{B}_{T}}}{{μ}_{1}} , \\ \overline{\overline{C}} = \frac{{μ}_{3} {μ}_{{C}_{P}}}{{μ}_{1} {μ}_{2}} {\overline{\overline{φ}}}_{P} + \frac{{μ}_{{C}_{T}}}{{μ}_{1}} , \\ \overline{\overline{D}} = \frac{{μ}_{3} {μ}_{{D}_{P}}}{{μ}_{1} {μ}_{2}} {\overline{\overline{φ}}}_{P} + \frac{{μ}_{{D}_{T}}}{{μ}_{1}} , \qquad ( 38 )$$

where the μ parameters are given in the “Definition of the Solution Parameters.” In this form, it becomes apparent that the coefficients a̅, b̅, A̅, B̅, C̅, D̅ (and by extension ā, b̅, Ā, B̅, C̅, D̅) govern the stress distribution via the thermal and mechanical load ratio, φ̅_{aR}, enhancing its relevance to the study of thermomechanical loading of lap joints.

The forms presented in Eqs. (37) and (38) will allow for an iterative version of the SO or SP solution to be applied using numerical methods, when the mechanical load is dependent on the thermal load. For example, this would allow for solution of displacement constrained thermomechanical problems.

### Boundary Conditions for the SP Solution

The pre-simplified version of the longitudinal normal stress boundary conditions for the left and right edges, respectively, are:

$$\overline{D} + \overline{C} + \overline{B} + \overline{A} - \frac{{\overline{φ}}_{T}}{\overline{γ}} - \frac{{\overline{φ}}_{P}}{\overline{γ}} = 0 , \\ {e}^{- {\overline{λ}}_{3}} \overline{D} + {e}^{{\overline{λ}}_{3}} \overline{C} + {e}^{- {\overline{λ}}_{1}} \overline{B} + {e}^{- {\overline{λ}}_{1}} \overline{A} - \frac{{\overline{φ}}_{T}}{\overline{γ}} - \frac{{\overline{φ}}_{P}}{\overline{γ}} - \frac{2 P}{{E}_{a 11} {t}_{a}} = 0. \qquad ( 39 )$$

When normalized by the total load total φ̅ₜₒₜₐₗ, the normal stress boundary conditions become:

$$\overline{D} + \overline{C} + \overline{B} + \overline{A} - \frac{1}{\overline{γ}} = 0 , \\ {e}^{- {\overline{λ}}_{3}} \overline{D} + {e}^{{\overline{λ}}_{3}} \overline{C} + {e}^{- {\overline{λ}}_{1}} \overline{B} + {e}^{{\overline{λ}}_{1}} \overline{A} - \frac{1}{\overline{γ}} - \frac{2 P}{{E}_{a 11} {t}_{a} {\overline{φ}}_{total}} = 0. \qquad ( 40 )$$

The pre-simplified version of the shear stress at the edges can be represented in either case by:

$$\frac{3 {α}_{b 33} {E}_{b 22} {l}^{4} {v}_{b 32} Δ T}{{E}_{a 11} {t}_{a} {t}_{b} {v}_{b 23} {v}_{b 32} - {E}_{a 11} {t}_{a} {{t}_{b}}_{ }} + \frac{3 {α}_{b 22} {E}_{b 22} {l}^{4} Δ T}{{E}_{a 11} {t}_{a} {t}_{b} {v}_{b 23} {v}_{b 32} - {E}_{a 11} {t}_{a} {t}_{b}} + \frac{( {E}_{{p}^{0}} {l}^{2} {\overline{λ}}_{3}^{2} {t}_{p} {v}_{b 23} {v}_{b 32} - {E}_{{p}^{0}} {l}^{2} {\overline{λ}}_{3}^{2} {t}_{p} + {E}_{b 22} {l}^{3} {\overline{λ}}_{3} ) \overline{D}}{{E}_{{p}^{0}} {t}_{p} {v}_{b 23} {v}_{b 32} - {E}_{{p}^{0}} {t}_{p}} + \frac{( {E}_{{p}^{0}} {l}^{2} {\overline{λ}}_{3}^{2} {t}_{p} {v}_{b 23} {v}_{b 32} - {E}_{{p}^{0}} {l}^{2} {\overline{λ}}_{3}^{2} {t}_{p} - {E}_{b 22} {l}^{3} {\overline{λ}}_{3} ) \overline{C}}{{E}_{{p}^{0}} {t}_{p} {v}_{b 23} {v}_{b 32} - {E}_{{p}^{0}} {t}_{p}} + \frac{( {E}_{{p}^{0}} {l}^{2} {\overline{λ}}_{1}^{2} {t}_{p} {v}_{b 23} {v}_{b 32} - {E}_{{p}^{0}} {l}^{2} {\overline{λ}}_{1}^{2} {t}_{p} + {E}_{b 22} {l}^{3} {\overline{λ}}_{1} ) \overline{B}}{{E}_{{p}^{0}} {t}_{p} {v}_{b 23} {v}_{b 32} - {E}_{{p}^{0}} {t}_{p}} + \frac{( {E}_{{p}^{0}} {l}^{2} {\overline{λ}}_{1}^{2} {t}_{p} {v}_{b 23} {v}_{b 32} - {E}_{{p}^{0}} {l}^{2} {\overline{λ}}_{1}^{2} {t}_{p} \times {E}_{b 22} {l}^{3} {\overline{λ}}_{1} ) \overline{A}}{{E}_{{p}^{0}} {t}_{p} {v}_{b 23} {v}_{b 32} - {E}_{{p}^{0}} {t}_{p}} = 0 , \\ \frac{3 {α}_{b 33} {E}_{b 22} {l}^{4} {v}_{b 32} Δ T}{{E}_{a 11} {t}_{a} {t}_{b} {v}_{b 23} {v}_{b 32} - {E}_{a 11} {t}_{a} {t}_{b}} + \frac{3 {α}_{b 22} {E}_{b 22} {l}^{4} Δ T}{{E}_{a 11} {t}_{a} {t}_{b} {v}_{b 23} {v}_{b 32} - {E}_{a 11} {t}_{a} {t}_{b}} + \frac{( \begin{matrix}{E}_{{p}^{1}} {l}^{2} {\overline{λ}}_{3}^{2} {e}^{- {\overline{λ}}_{3}} {t}_{p} {v}_{b 23} {v}_{b 32} - \\ {E}_{{p}^{1}} {l}^{2} {\overline{λ}}_{3}^{2} {e}^{- {\overline{λ}}_{3}} {t}_{p} + {E}_{b 22} {l}^{3} {\overline{λ}}_{3} {e}^{- {\overline{λ}}_{3}}\end{matrix} ) \overline{D}}{{E}_{{p}^{1}} {t}_{p} {v}_{b 23} {v}_{b 32} - {E}_{{p}^{1}} {t}_{p}} \frac{( {E}_{{p}^{1}} {l}^{2} {\overline{λ}}_{3}^{2} {e}^{- {\overline{λ}}_{3}} {t}_{p} {v}_{b 23} {v}_{b 32} - {E}_{{p}^{1}} {l}^{2} {\overline{λ}}_{3}^{2} {e}^{{\overline{λ}}_{3}} {t}_{p} - {E}_{b 22} {l}^{3} {\overline{λ}}_{3} {e}^{{\overline{λ}}_{3}} ) \overline{C}}{{E}_{{p}^{1}} {t}_{p} {v}_{b 23} {v}_{b 32} - {E}_{{p}^{1}} {t}_{p}} + \frac{( \begin{matrix}{E}_{{p}^{1}} {l}^{2} {\overline{λ}}_{1}^{2} {e}^{- {\overline{λ}}_{1}} {t}_{p} {v}_{b 23} {v}_{b 32} - \\ {E}_{{p}^{1}} {l}^{2} {\overline{λ}}_{1}^{2} {e}^{- {\overline{λ}}_{1}} {t}_{p} + {E}_{b 22} {l}^{3} {\overline{λ}}_{1} {e}^{- {\overline{λ}}_{1}}\end{matrix} ) \overline{B}}{{E}_{{p}^{1}} {t}_{p} {v}_{b 23} {v}_{b 32} - {E}_{{p}^{1}} {t}_{p}} + \frac{( {E}_{{p}^{1}} {l}^{2} {\overline{λ}}_{1}^{2} {e}^{{\overline{λ}}_{1}} {t}_{p} {v}_{b 23} {v}_{b 32} - {E}_{{p}^{1}} {l}^{2} {\overline{λ}}_{1}^{2} {e}^{{\overline{λ}}_{1}} {t}_{p} - {E}_{b 22} {l}^{3} {\overline{λ}}_{1} {e}^{{\overline{λ}}_{1}} ) \overline{A}}{{E}_{{p}^{1}} {t}_{p} {v}_{b 23} {v}_{b 32} - {E}_{{p}^{1}} {t}_{p}} = 0. \qquad ( 41 )$$

### Definition of the Solution Parameters

### System Parameters λ̅_{[13]} in Terms of the Orthotropic Material Properties

$${\overline{λ}}_{[ 13 ]}^{2} = \frac{\pm \sqrt{\frac{9 {E}_{b 22}^{2} {l}^{4}}{4 {G}_{b 12}^{2} {{t}_{b}^{4} ( {v}_{b 23} {v}_{b 32} - 1 )}^{2}} - \frac{\begin{matrix}12 {E}_{b 22} {l}^{4} ( {E}_{a 11} {t}_{a} {v}_{c 13} {v}_{c 31} + \\ \begin{matrix}2 {E}_{c 11} {t}_{c} {v}_{a 13} {v}_{a 31} - \\ 2 {E}_{c 11} {t}_{c} - {E}_{a 11} {t}_{a} )\end{matrix}\end{matrix}}{{E}_{a 11} {E}_{c 11} {t}_{a} {t}_{b}^{3} {t}_{c} ( {v}_{b 23} {v}_{b 32} - 1 )}}}{2} - \frac{3 {E}_{b 22} {l}^{2}}{4 {G}_{b 12} {t}_{b}^{2} ( {v}_{b 23} {v}_{b 32} - 1 )} . \qquad ( 42 )$$

### μ Parameters for the SP Solution Coefficients

The μ values of Eqs. (28) and (38) are given by:

$${μ}_{{A}_{T}} = \frac{{\overline{λ}}_{3} ( {e}^{{\overline{λ}}_{3}} - 1 )}{\overline{γ}} \\ {μ}_{{B}_{T}} = \frac{{e}^{{\overline{λ}}_{1}} {\overline{λ}}_{3} ( {e}^{{\overline{λ}}_{3}} - 1 )}{\overline{γ}} \\ {μ}_{{C}_{T}} = \frac{{\overline{λ}}_{1} ( {e}^{{\overline{λ}}_{1}} - 1 )}{\overline{γ}} \\ {μ}_{{D}_{T}} = \frac{{\overline{λ}}_{1} ( {e}^{{\overline{λ}}_{1}} - 1 ) {e}^{{\overline{λ}}_{3}}}{\overline{γ}} \\ {μ}_{{A}_{P}} = - ( \begin{matrix}{\overline{λ}}_{3} {e}^{2 {\overline{λ}}_{3} + {\overline{λ}}_{1} } - {\overline{λ}}_{1} {e}^{2 {\overline{λ}}_{3} + {\overline{λ}}_{1}} + 2 {\overline{λ}}_{1} {e}^{{\overline{λ}}_{3}} - \\ {e}^{{\overline{λ}}_{1}} {\overline{λ}}_{3} - {\overline{λ}}_{1} {e}^{{\overline{λ}}_{1}}\end{matrix} ) \\ {μ}_{{B}_{P}} = {e}^{{\overline{λ}}_{1}} ( \begin{matrix}- 2 {\overline{λ}}_{1} {e}^{{\overline{λ}}_{3} + {\overline{λ}}_{1}} + {\overline{λ}}_{3} {e}^{2 {\overline{λ}}_{3}} + \\ {\overline{λ}}_{1} {e}^{2 {\overline{λ}}_{3}} - {\overline{λ}}_{3} + {\overline{λ}}_{1}\end{matrix} ) \\ {μ}_{{C}_{P}} = \frac{{\overline{λ}}_{1} ( \begin{matrix}{\overline{λ}}_{3} {e}^{{\overline{λ}}_{3} + 2 {\overline{λ}}_{1}} - {\overline{λ}}_{1} {e}^{{\overline{λ}}_{3} + 2 {\overline{λ}}_{1}} + \\ {\overline{λ}}_{1} {e}^{{\overline{λ}}_{3}} + {\overline{λ}}_{1} {e}^{{\overline{λ}}_{3}} - 2 {e}^{{\overline{λ}}_{1}} {\overline{λ}}_{3}\end{matrix} )}{{\overline{λ}}_{3}} \\ {μ}_{{D}_{P}} = - \frac{{\overline{λ}}_{1} {e}^{{\overline{λ}}_{3}} ( \begin{matrix}2 {\overline{λ}}_{3} {e}^{{\overline{λ}}_{3} + {\overline{λ}}_{1}} - {e}^{2 {\overline{λ}}_{1}} {\overline{λ}}_{3} - \\ {\overline{λ}}_{3} - {\overline{λ}}_{1} {e}^{2 {\overline{λ}}_{1}} + {\overline{λ}}_{1}\end{matrix} )}{{\overline{λ}}_{3}} \\ {μ}_{1} = \begin{matrix}{\overline{λ}}_{3} {e}^{{\overline{λ}}_{3} + {\overline{λ}}_{1}} - {\overline{λ}}_{1} {e}^{{\overline{λ}}_{3} + {\overline{λ}}_{1}} + {\overline{λ}}_{3} {e}^{{\overline{λ}}_{3}} + \\ {\overline{λ}}_{3} {e}^{{\overline{λ}}_{3}} - {e}^{{\overline{λ}}_{1}} {\overline{λ}}_{3} - {\overline{λ}}_{3} + {\overline{λ}}_{1} {e}^{{\overline{λ}}_{1}} + {\overline{λ}}_{1}\end{matrix} \\ {μ}_{2} = \begin{matrix}{\overline{λ}}_{3} {e}^{{\overline{λ}}_{3} + {\overline{λ}}_{1}} - {\overline{λ}}_{1} {e}^{{\overline{λ}}_{3} + {\overline{λ}}_{1} -} {\overline{λ}}_{3} {e}^{{\overline{λ}}_{3}} - \\ {\overline{λ}}_{1} {e}^{{\overline{λ}}_{3}} + {e}^{{\overline{λ}}_{1}} {\overline{λ}}_{3} - {\overline{λ}}_{3} + {\overline{λ}}_{1} {e}^{{\overline{λ}}_{1}} + {\overline{λ}}_{1}\end{matrix} \\ {μ}_{3} = \frac{{E}_{c 11} {\overline{λ}}_{3} {t}_{b}^{3} {t}_{c} ( {v}_{b 23} {v}_{b 32} - 1 )}{3 {E}_{b 22} {l}^{4} ( {v}_{c 13} {v}_{c 31} - 1 )} . \qquad ( 43 )$$

### Nomenclature

t_{κ} material thickness of component κ, m
l lap length, m
x lap coordinate measured from the left edge, m
y lap coordinate measured from the lower edge, m
σ_{κ11(x)} longitudinal stress in component κ, Pa
σ_{κ22(x,y)} transverse stress in component κ, Pa
τ_{κ12(x)} shear stress in component κ, Pa
E_{κii} orthotropic engineering moduli of component κ; Pa
G_{b12} shear modulus of the adhesive, Pa
Eₚ_{^{[01]}} Young's moduli of the end posts, Pa
v_{κij} Poisson's ratios of component κ
α_{κii} orthotropic thermal expansion coefficient of component κ, ° C.⁻¹
P mechanical load applied to joint, per unit depth, N m⁻¹
ΔT temperature change from reference temperature, ° C.
F mechanical load carried by an end post, N
c₀, d₀ coefficients of assumed stress distribution, N
c₁, d₁ coefficients of assumed stress distribution, N m⁻¹
Ψ_{P} mechanical load parameter, N m⁻⁴
Ψ_{P} mechanical load parameter, N m⁻⁶
Ψ_{T} thermal load parameter, N m⁴
φ_{T} thermal load parameter, N m⁻⁶
ω system parameter, m⁻¹
β system parameter, m⁻²
γ system parameter, m⁻⁴
x̅ dimensionless coordinate x/l measured from the left edge of the adhesive
ω̅ dimensionless system parameter
β̅, γ̅, dimensionless system parameters
λ̅₁, λ̅₃ dimensionless system parameters
σ̅_{κ11(x)} dimensionless longitudinal stress in component κ
σ̅_{κ22(x,y)} dimensionless transverse stress in component κ
τ̅_{κ12(x)} dimensionless shear stress in component κ
σ̅ₐ₁₁₍ₓ₎ normalized dimensionless longitudinal stress in component a
Ψ̅_{P}, φ̅_{P} dimensionless mechanical load parameters
Ψ̅_{T}, φ̅_{T} dimensionless thermal load parameters
φ̅_{aR}, φ̅_{cR} dimensionless thermal to mechanical load ratios
φ̅ₜₒₜₐₗ dimensionless total load parameter
φ̅_{P} dimensionless mechanical load fraction
ā, b̅, Ā, B̅, C̅, D̅ dimensionless coefficients
a̅, b̅, A̅, B̅, C̅, D̅ dimensionless coefficients
\hat{σ}_{κ11(x)} longitudinal virtual stress in component κ
\hat{σ}_{κ22(x,y)} transverse virtual stress in component κ
\hat{τ}_{κ12(x)} shear virtual stress in component κ
[ ] the or operator, i.e., [13] is 1 or 3 (no sum)
κ κ=[abc] (no sum) representing central adherend (a), adhesive (b), and outer adherend (c), respectively
ii i=[123] (no sum)
ii i,j=[123] where i≠j (no sum)

### APPENDIX C

### Formulation of the Finite Element

FIG. 3B schematically shows the MBJFE 18. The element is a 1D element, with all displacement degrees of freedom being oriented along the 1-axis. Two of the displacement degrees of freedom, q₁ and q₄, are external degrees of freedom which connect the joint element to the external structure. The remaining displacement degrees of freedom are internal to the element, and are used in conjunction with Lagrange multipliers in order to determine the mechanical loading fraction, φ̅_{P}, required for determination of the stress and strain fields. The mechanical load that is carried across the joint 18 is calculated using internal degrees of freedom, P₁ and P₂.

The element 18 is formulated in stages, first the outer section sub-elements 28 are analyzed from the equilibrium stress equation, so that the analysis can subsequently be generalized for the joint section. This approach is required, in contrast to assuming polynomial shape functions and deriving field quantities from them, since the displacement field is governed by a load character dependent exponential equation within the adhesively bonded section.

For this derivation, all sections of the joint element 18 are assumed to have plane strain, linear elastic, orthotropic constitutive response. The constitutive description of constituent κ is given by Eq. (1), which also accounts for temperature effects.

$$\{ \begin{matrix}{ε}_{κ 11} ( x ) \\ {ε}_{κ 22} ( x ) \\ {γ}_{κ 12} ( x )\end{matrix} \} = [ \begin{matrix}\frac{1 - {v}_{κ 13} {v}_{κ 31}}{{E}_{κ 11}} & - \frac{{v}_{κ 23} {v}_{κ 31} + {v}_{κ 21}}{{E}_{κ 22}} & 0 \\ - \frac{{v}_{κ 13} {v}_{κ 32} + {v}_{κ 12}}{{E}_{κ 11}} & \frac{1 - {v}_{κ23} {v}_{κ 32}}{{E}_{κ 22}} & 0 \\ 0 & 0 & \frac{1}{{G}_{κ 12}}\end{matrix} ] \{ \begin{matrix}{σ}_{κ 11} ( x ) \\ {σ}_{κ 22} ( x ) \\ {τ}_{κ 12} ( x )\end{matrix} \} + [ \begin{matrix}{α}_{κ 33} {v}_{κ 31} + {α}_{κ 11} \\ {α}_{κ 33} {v}_{κ 32} + {α}_{κ 22} \\ 0\end{matrix} ] Δ T \qquad ( 1 )$$

Stiffness and Load Contribution of the Adherends Outside of the Bonded Region The stress in the adherends 10, 12 (FIG. 1) outside the bonded region are assumed to have no transverse stress, σ_{κ22}=0. For the purpose of the initial portion of this derivation, all Poisson terms will be set to zero, making the subsections outside the joint equivalent to truss elements. A more general analysis would include these terms, however retaining them in this section does not add value and in fact deters the intended demonstration.

As a preface to the remainder of this section, the derivation presented here may seem unnecessary, since the truss element is widely understood and easily derived. The reader could skip to the next section without loss of substance. The subsequent non-linear analysis of the joint section, however, is carried out in exactly the same manner. The intermediate results of that section are too long to be included, so the detailed steps of the derivation are presented here where they can be easily understood. With a view to how the shape functions for the bonded section can be obtained, the stress field in the outer center adherend is written directly from equilibrium:

$${σ}_{c11} ( \overline{x} ) = \frac{P}{{t}_{c}} , \qquad ( 2 )$$

where x̅ is the natural coordinate of this section, defined as:

$$\overline{x} = \frac{x}{l} . \qquad ( 3 )$$

The sub-element local x, y directions are defined from the left edge of the subelement 28, and the sub-element length is lₑ, as shown in FIG. 7. Assume the system has only an extensional degree of freedom given by:

qₑ=q₄−q₃. (4)

From Eq. (1) and Eq. (2), the strain field can be written as:

$${ε}_{c 11} ( \overline{x} ) = \frac{{σ}_{c 11} ( \overline{x} )}{{E}_{c 11}} + {α}_{c 11} Δ T \qquad ( 5 )$$

The strain field is integrated to obtain the axial displacement field,

$${u}_{c} ( \overline{x} ) = \int {ε}_{c 11} ( \overline{x} ) ( \frac{d x}{d \overline{x}} ) d \overline{x} , \qquad ( 6 )$$

and the extension qₑ is given by:

$${u}_{c} ( \overline{x} = 1 ) = {q}_{e} = {l}_{e} [ \frac{P}{{E}_{c 11} {t}_{c}} + {α}_{c 11} Δ T ] . \qquad ( 7 )$$

To obtain generalized loads for the sub-element 28, the following substitutions are made:

$$P = \frac{{\overline{ψ}}_{P} {E}_{c 11} {t}_{c}}{{l}_{e}} \\ Δ T = \frac{{l}_{e} {\overline{ψ}}_{T}}{{α}_{c 11}} , \qquad ( 8 )$$

where Ψ̅_{T} and Ψ̅_{P} are dimensionless thermal and mechanical loads respectively. Additionally, the following substitutions are made in order to rewrite all critical values in terms of the mechanical load fraction Ψ̅_{P} and total load Ψ̅ₜₒₜₐₗ:

Ψ̅ₜₒₜₐₗ= Ψ̅_{T}+ Ψ̅_{P},

Ψ̅_{T}= Ψ̅ₜₒₜₐₗ(1= Ψ̅_{P}), (9)

as was done in Appendix B. The axial displacement field is then written as:

$${u}_{c} ( \overline{x} ) = {l}_{e} {\overline{ψ}}_{total} \overline{x} ( \frac{{\overline{\overline{ψ}}}_{P}}{{E}_{c 11} {t}_{c}} - {l}_{e} {\overline{\overline{ψ}}}_{P} + {l}_{e} ) , \qquad ( 10 )$$

and the extension DOF is written as:

$${q}_{e} = {l}_{e} {\overline{ψ}}_{total} ( \frac{{\overline{\overline{ψ}}}_{P}}{{E}_{c 11} {t}_{c}} - {l}_{e} {\overline{\overline{ψ}}}_{P} + {l}_{e} ) . \qquad ( 11 )$$

Since the displacement field of Eq. (10) is written in terms of the total load Ψ̅ₜₒₜₐₗ (which is not known in general), the total load can now be written as a linear function of the extension DOF, qₑ, and the mechanical load fraction Ψ̅_{P},

$${\overline{ψ}}_{total} = - \frac{{E}_{c 11} {q}_{e} {t}_{c}}{( {E}_{c 11} {l}_{e}^{2} {t}_{c} - {l}_{e} ) {\overline{\overline{ψ}}}_{P} - {E}_{c 11} {l}_{e}^{2} {t}_{c}} . \qquad ( 12 )$$

When the displacement field of Eq. (6) is rewritten with the substitution of Eq. (12), the linear displacement field is recovered and can be written as a shape function N( x̅, Ψ̅_{P}).

u_{c}( x̅)= x̅qₑ=N( x̅, Ψ̅_{P})qₑ (13)

The strain and stress are now written in terms of qₑ and the shape function derivative B( x̅, Ψ̅_{P})),

$$\begin{matrix}{ε}_{c 11} ( \overline{x} ) = ( \frac{d \overline{x}}{d x} ) \frac{d}{d \overline{x}} {u}_{c} ( \overline{x} ) = \frac{B ( x , {{ψ}^{\overline{\_}}}_{P} ) ) {q}_{e}}{{l}_{e}} , & ( 14 ) \\ \\ \begin{matrix}{σ}_{c 11} ( \overline{x} ) = {E}_{c 11} ( {ε}_{c 11} - {α}_{c 11} Δ T ) \\ = {E}_{c 11} ( \frac{B ( \overline{x} , {{ψ}^{\overline{\_}}}_{P} ) ) {q}_{e}}{{l}_{e}} - {α}_{c 11} Δ T ) ,\end{matrix} & ( 15 )\end{matrix}$$

where in this case of the central adherend 10 outside the bonded section, B( x̅, Ψ̅_{P))=}1.

The strain energy and external work terms are:

$$U = {\int }_{0}^{{t}_{c}} {\int }_{0}^{1} {σ}_{c 11} ( \overline{x} , {\overline{\overline{ψ}}}_{P} ) {ε}_{c 11} ( \overline{x} , {\overline{\overline{ψ}}}_{P} ) ( \frac{d x}{d \overline{x}} ) d \overline{x} d y , \\ W = {P}_{{q}_{e}} . \qquad ( 16 )$$

In contrast to Eq. (2) which was used to obtain the shape functions, Eqs. (15) and (16) are written in terms of the temperature change, ΔT, and load, P, since the current object is to obtain the stiffness matrix and load vector for this sub-element.

At this point it is appropriate to substitute the displacements q₃, q₄, in place of the extension, qₑ. The strain energy is now written in terms of the displacements:

$$U = \frac{{E}_{c 11} ( {q}_{4} - {q}_{3} ) {\int }_{y 0}^{y 1} {\int }_{0}^{1} B ( \overline{x} , {\overline{\overline{ψ}}}_{P} ) ( ( {q}_{4} - {q}_{3} ) B ( \overline{x} , {\overline{\overline{ψ}}}_{P} ) - {α}_{c 11} {l}_{e} Δ T ) d \overline{x} d y}{{l}_{e}} . \qquad ( 17 )$$

The potential energy equation can now be written, from which the governing equations (in matrix form) are derived:

$$\begin{matrix}\frac{d}{d \vec{{q}_{e}}} Π = \frac{d}{d \vec{{q}_{e}}} ( U - W ) = 0 , \\ K \vec{{q}_{e}} = \vec{F} .\end{matrix} \qquad ( 18 )$$

The sub-element stiffness matrix, Kₑ, is:

$${K}_{e} = \frac{{E}_{c 11} {\int }_{y 0}^{y 1} {\int }_{0}^{1} {B}^{2} ( \overline{x} , {{ψ}^{\overline{\_}}}_{P} ) d \overline{x} d y}{{l}_{e}} [ \begin{matrix}1 & - 1 \\ - 1 & 1\end{matrix} ] , \qquad ( 19 )$$

and the sub-element load vector, \vec{F}, is:

$$\vec{F} = P \{ \begin{matrix}- 1 \\ 1\end{matrix} \} + {α}_{c 11} {E}_{c 11} ( {\int }_{y 0}^{y 1} {\int }_{0}^{1} B ( \overline{x} , {{ψ}^{\overline{\_}}}_{P} ) d \overline{x} d y ) Δ T \{ \begin{matrix}- 1 \\ 1\end{matrix} \} . \qquad ( 20 )$$

It can be easily seen upon examining Eqs. (19) and (20) that when B( x̅, Ψ̅_{P})=1 is applied for the sub-element 28, the appropriate truss element stiffness is recovered. Identical sub-element formulations are used for the central adherend 10 and outer adherends 12 (external to the bonded section). It has been shown in this subsection that the sub-element stiffness and load quantities can be derived using non-dimensionalized loads and their ratios.

### Stiffness and Load Contribution of the Adhesively Bonded Section

In the prior section, a general method was presented for calculating a stiffness matrix and load vector which are load dependent. More specifically, the stiffness matrix and load vector were derived in such a way that they are functions of the ratio of nondimensional thermal and mechanical loads, rewritten in terms of the mechanical load fraction Ψ̅_{P}. Although the preceding truss type element derived necessarily resulted in a linear displacement field and load independent stiffness matrix, the derivation method is general and is used in this section for the displacement field of the symmetric double lap joint derived in Appendix B.

Following the order of the derivation in the prior section and applying it to the subelement 30 shown in FIG. 8, the stress field must be known. Within the assumptions of its derivation, the double lap joint stress field contains the following components for the adherends and adhesive:

$$\begin{matrix}{σ}_{a 11} ( \overline{x} , {{φ}^{\overline{\_}}}_{P} , {{φ}^{\overline{\_}}}_{total} ) = {E}_{a 11} {\overline{φ}}_{total} \\ ( {A}^{\overline{\_}} {e}^{{\overline{λ}}_{1} \overline{x}} + {B}^{\overline{\_}} {e}^{- {\overline{λ}}_{1} \overline{x}} {C}^{\overline{\_}} {e}^{{\overline{λ}}_{3} \overline{x}} + \overline{\overline{D}} {e}^{- {\overline{λ}}_{3} \overline{x}} + - \frac{1}{\overline{γ}} ) \\ {σ}_{b 12} ( \overline{x} , {{φ}^{\overline{\_}}}_{P} , {{φ}^{\overline{\_}}}_{total} ) = - \frac{{t}_{a}}{2} \frac{d \overline{x}}{d x} ( \frac{d}{d \overline{x}} {σ}_{a 11} ( \overline{x} , {{φ}^{\overline{\_}}}_{P} , {{φ}^{\overline{\_}}}_{total} ) ) \\ {σ}_{b 22} ( \overline{x} , y , {{φ}^{\overline{\_}}}_{P} , {{φ}^{\overline{\_}}}_{total} ) = \frac{{t}_{a}}{2} {( \frac{d \overline{x}}{d x} )}^{2} ( \frac{{d}^{2}}{d {\overline{x}}^{2}} {σ}_{a 11} ( \overline{x} , {{φ}^{\overline{\_}}}_{P} , {{φ}^{\overline{\_}}}_{total} ) ) \\ ( y - {t}_{b} ) \\ {σ}_{c 11} ( \overline{x} , {{φ}^{\overline{\_}}}_{P} , {{φ}^{\overline{\_}}}_{total} ) = \frac{P}{{t}_{c}} - \frac{{t}_{a} {σ}_{a 11} ( \overline{x} , {{φ}^{\overline{\_}}}_{P} , {{φ}^{\overline{\_}}}_{total} ) t}{2 {t}_{c}}\end{matrix} \qquad ( 21 )$$

In Eq. (21), the constants ( A̅( φ̅_{P}), B̅( φ̅_{P}), C̅( φ̅_{P}), D̅( φ̅_{P}) are non-dimensional system coefficients that are functions of the mechanical load fraction φ̅_{P}, and are provided in Appendix B. For brevity, the function representation is dropped, and these coefficients are left as A̅, B̅, C̅, D̅. The orthotropic material properties of the constituents are represented using E_{κij}, G_{κij}, v_{κij} and t_{κ} for moduli, Poisson's ratios, and thicknesses of the constituent κ. The stress components not listed in Eq. (21) can be determined but are of less interest.

Knowing the stress field, the strain fields in the adherends are calculated directly from Eq. (1). As in the previous section, non-dimensionalizing substitutions are made for the loads:

ΔT=XT φ̅T,

P=XP φ̅P, (22)

where the non-dimensionalizing coefficients are given by:

$$\begin{matrix}{χ}_{T} = \frac{{E}_{a 11} {t}_{a} {t}_{b}^{3} ( {v}_{b 23} {v}_{b 32} - 1 )}{6 {E}_{b 22} {l}_{e}^{4} ( {α}_{c 33} {v}_{c 31} - {α}_{a 33} {v}_{a 31} + {α}_{c 11} - {α}_{a 11} )} , \\ {χ}_{P} = - \frac{{E}_{a 11} {E}_{c 11} {t}_{a} {t}_{b}^{3} {t}_{c} ( {v}_{b 23} {v}_{b 32} - 1 )}{6 {E}_{b 22} {l}_{e}^{4} ( {v}_{c 13 } {v}_{c 31} - 1 )} .\end{matrix} \qquad ( 23 )$$

All loads are written in terms of the total load and mechanical load fraction by the following substitutions:

φ̅_{T}= φ̅ₜₒₜₐₗ− φ̅ₚ,

φ̅_{P}= φ̅_{P} φ̅ₜₒₜₐₗ. (24)

Applying Eqs. (22) and (23) to the known stress field and constitutive law, the strain can be written as a linear function of the total load φ̅ₜₒₜₐₗ. Looking towards the stiffness and load vectors of this sub-element, the elongation in the local x direction is important. The two strain fields of interest are the strain in the outer and central adherends:

$$\begin{matrix}\frac{{ε}_{a 11} ( \overline{x} , {{φ}^{\overline{\_}}}_{P} , {{φ}^{\overline{\_}}}_{total} )}{{{φ}^{\overline{\_}}}_{total}} = ( 1 - {v}_{a 13} {v}_{a 31} ) \\ ( {e}^{- {\overline{λ}}_{3} \overline{x}} {D}^{\overline{\_}} + {e}^{{\overline{λ}}_{3} \overline{x}} {C}^{\overline{\_}} + {e}^{- {\overline{λ}}_{1} \overline{x}} {B}^{\overline{\_}} + {e}^{{\overline{λ}}_{1} \overline{x}} {A}^{\overline{\_}} - \frac{1}{\overline{γ}} ) + \\ {χ}_{T } ( 1 - {{φ}^{\overline{\_}}}_{P} ) ( {α}_{a 33} {v}_{a 31} + {α}_{a 11} ) , \\ \frac{{ɛ}_{c 11} ( \overline{x} , y , {{φ}^{\overline{\_}}}_{P} , {{φ}^{\overline{\_}}}_{total} )}{{{φ}^{\overline{\_}}}_{total}} = \frac{{E}_{a 11} {t}_{a} ( {v}_{c 13} {v}_{c 31} - 1 )}{2 {E}_{c 11} {t}_{c}} ( {e}^{- {\overline{λ}}_{3} \overline{x}} {D}^{\overline{\_}} + {e}^{{\overline{λ}}_{3} \overline{x}} {C}^{\overline{\_}} + \\ {e}^{- {\overline{λ}}_{1} \overline{x}} {B}^{\overline{\_}} + {e}^{{\overline{λ}}_{1} \overline{x}} {A}^{\overline{\_}} ) + \\ {χ}_{T } ( 1 - {{φ}^{\overline{\_}}}_{P} ) ( {α}_{c 11} + {α}_{c 33} {v}_{c 31} ) + \\ \frac{1}{{E}_{c 11} {t}_{c}} ( 1 - {v}_{c 13} {v}_{c 31} ) ( \frac{{E}_{a 11} {t}_{a}}{2 \overline{γ}} + \frac{{{φ}^{\overline{\_}}}_{P} {χ}_{P}}{1} ) .\end{matrix} \qquad ( 25 )$$

Assuming that the total elongation of the sub-element adherends is identical and given by qₑ, the two elongation equations are written as:

$$\begin{matrix}{q}_{e} = \frac{d x}{d \overline{x}} {\int }_{0}^{1} {ε}_{a 11} ( \overline{x} , {{φ}^{\overline{\_}}}_{P} , {{φ}^{\overline{\_}}}_{total} ) d \overline{x} , \\ {q}_{e} = \frac{d x}{d \overline{x}} {\int }_{0}^{1} {ε}_{c 11} ( \overline{x} , {{φ}^{\overline{\_}}}_{P} , {{φ}^{\overline{\_}}}_{total} ) d \overline{x} .\end{matrix} \qquad ( 26 )$$

In Eq. (26), the elongation is written as a function of the non-dimensional total load, φ̅ₜₒₜₐₗ. As was done for the sub-element in the previous section, the total load is not known a priori and must be eliminated in favor of the total elongation qₑ. This is accomplished by applying the boundary condition to the result of Eq. (26):

$$\begin{matrix}{[ \frac{d x}{d \overline{x}} {\int }_{0}^{1} {ε}_{a 11} ( \overline{x} , {{φ}^{\overline{\_}}}_{P} , {{φ}^{\overline{\_}}}_{total} ) d \overline{x} ]}_{\overline{x} = 0} = 0 , \\ {[ \frac{d x}{d \overline{x}} {\int }_{0}^{1} {ε}_{a 11} ( \overline{x} , {{φ}^{\overline{\_}}}_{P} , {{φ}^{\overline{\_}}}_{total} ) d \overline{x} ]}_{\overline{x} = 1} = {q}_{e} , \\ {[ \frac{d x}{d \overline{x}} {\int }_{0}^{1} {ε}_{c 11} ( \overline{x} , {{φ}^{\overline{\_}}}_{P} , {{φ}^{\overline{\_}}}_{total} ) d \overline{x} ]}_{\overline{x} = 0} = 0 , \\ {[ \frac{d x}{d \overline{x}} {\int }_{0}^{1} {ε}_{c 11} ( \overline{x} , {{φ}^{\overline{\_}}}_{P} , {{φ}^{\overline{\_}}}_{total} ) d \overline{x} ]}_{\overline{x} = 1} = {q}_{e} ,\end{matrix} \qquad ( 27 )$$

Specifically, the boundary condition is that adherend elongation is zero when x̅=0, and the total elongation is qₑ when x̅=1. Applying these boundary conditions and solving for the total load φ̅ₜₒₜₐₗ, elimination constants Φ̅ₐ and Φ̅_{c} are written as:

$$\begin{matrix}{{Φ}^{\overline{\_}}}_{a} = \frac{{\overline{λ}}_{1} {\overline{λ}}_{3} {e}^{{\overline{λ}}_{3} + {\overline{λ}}_{1}}}{{{Ξ}^{\overline{\_}}}_{α}} , \\ {{Φ}^{\overline{\_}}}_{c} = \frac{{\overline{λ}}_{1} {\overline{λ}}_{3} {e}^{{\overline{λ}}_{3} + {\overline{λ}}_{1}}}{{{Ξ}^{\overline{\_}}}_{c} .}\end{matrix} \qquad ( 28 )$$

The denominators of the elimination constants, Ξ̅ₐ and Ξ̅_{c}, are detailed in the “Denominators of the Elimination Coefficients.” Substituting Eq. (28) into Eq. (25), the displacement field is known and the shape functions and shape functions derivatives can now be written for each adherend 10, 12:

$$\begin{matrix}{u}_{a} ( \overline{x} , {{φ}^{\overline{\_}}}_{P} , {q}_{e} ) = {N}_{a} ( \overline{x} , {{φ}^{\overline{\_}}}_{P} ) {q}_{e} , \\ {u}_{c} ( \overline{x} , {{φ}^{\overline{\_}}}_{P} , {q}_{e} ) = {N}_{c} ( \overline{x} , {{φ}^{\overline{\_}}}_{P} ) {q}_{e} , \\ {B}_{a} ( \overline{x} , {{φ}^{\overline{\_}}}_{P} ) = \frac{d}{d \overline{x}} {N}_{a} ( \overline{x} , {{φ}^{\overline{\_}}}_{P} ) , \\ {B}_{c} ( \overline{x} , {{φ}^{\overline{\_}}}_{P} ) = \frac{d}{d \overline{x}} {N}_{c} ( \overline{x} , {{φ}^{\overline{\_}}}_{P} ) .\end{matrix} \qquad ( 29 )$$

The functions in Eq. (29) are detailed in the “Shape Functions and Derivatives within the Bonded Region.” The stiffness matrix and load vector can now be integrated numerically using Eqs. (19), (20) and Eq. (29).

### Calculation of the Load Carried Across the Bonded Section

The mechanical load P is a component of the load character of the bonded section sub-element, and therefore may be determined. Using the equilibrium equation for the central adherend outside the bonded section, it is known that the internal load is determined by the following equation:

$$\frac{E {t}_{a}}{{l}_{e}} {q}_{e} = {P}_{2} \qquad ( 30 )$$

In terms of the displacement DOFs, the above equation can be written as a Lagrange multiplier augmentation to the sub-element stiffness matrix for the central adherend outside the bonded section:

$$[ \begin{matrix}\frac{{E}_{c 11} {t}_{c}}{{l}_{e}} & - \frac{{E}_{c 11} {t}_{c}}{{l}_{e}} & 0 \\ - \frac{{E}_{c 11} {t}_{c}}{{l}_{e}} & \frac{{E}_{c 11} {t}_{c}}{{l}_{e}} & 0 \\ \frac{{E}_{c 11} {t}_{c}}{{l}_{e}} & - \frac{{E}_{c 11} {t}_{c}}{{l}_{e}} & 1\end{matrix} ] \{ \begin{matrix}{q}_{3} \\ {q}_{4} \\ {P}_{2}\end{matrix} \} = \{ \begin{matrix}{F}_{3} \\ {F}_{4} \\ 0\end{matrix} \} , \qquad ( 31 )$$

In this way, the mechanical load P is now written as a degree of freedom which is solved during every increment.

### Denominators of the Elimination Coefficients

The denominators from Eq. (28) are:

$$\begin{matrix}{{Ξ}^{\overline{\_}}}_{a} = + {l}_{e} {\overline{λ}}_{1} ( 1 - {v}_{a 13} {v}_{a 31} ) ( {e}^{{\overline{λ}}_{3} + {\overline{λ}}_{1}} - {e}^{{\overline{λ}}_{1}} ) {D}^{\overline{\_}} + \\ {l}_{e} {\overline{λ}}_{1} ( 1 - {v}_{a 13} {v}_{a 31} ) ( {e}^{2 {\overline{λ}}_{3} + {\overline{λ}}_{1}} - {e}^{{\overline{λ}}_{3} + {\overline{λ}}_{1}} ) {C}^{\overline{\_}} + \\ {l}_{e} {\overline{λ}}_{3} ( 1 - {v}_{a 13} {v}_{a 31} ) ( {e}^{{\overline{λ}}_{3} + {\overline{λ}}_{1}} - {e}^{{\overline{λ}}_{3}} ) {B}^{\overline{\_}} + \\ {l}_{e} {\overline{λ}}_{3} ( 1 - {v}_{a 13} {v}_{a 31} ) ( {e}^{{\overline{λ}}_{3} + 2 {\overline{λ}}_{1}} - {e}^{{\overline{λ}}_{3} + {\overline{λ}}_{1}} ) {A}^{\overline{\_}} - \\ {l}_{e} {\overline{λ}}_{1} {\overline{λ}}_{3} {e}^{{\overline{λ}}_{3} + {\overline{λ}}_{1}} \\ ( \frac{( 1 - {v}_{a 13} {v}_{a 31} )}{\overline{γ}} - {χ}_{T} ( 1 - {{φ}^{\overline{\_}}}_{P} ) ( {α}_{a 11} + {α}_{a 33} {v}_{a 31} ) ) , \\ {{Ξ}^{\overline{\_}}}_{c} = - \frac{{E}_{a 11} {t}_{a}}{2 {E}_{c 11} {t}_{c}} {l}_{e} {\overline{λ}}_{1} ( 1 - {v}_{c 13} {v}_{c 31} ) ( {e}^{{\overline{λ}}_{1}} + {e}^{{\overline{λ}}_{3} + {\overline{λ}}_{1}} ) {D}^{\overline{\_}} - \\ \frac{{E}_{a 11} {t}_{a}}{2 {E}_{c 11} {t}_{c}} {l}_{e} {\overline{λ}}_{1} ( 1 - {v}_{c 13} {v}_{c 31} ) ( {e}^{2 {\overline{λ}}_{3} + {\overline{λ}}_{1}} - {e}^{{\overline{λ}}_{3} + {\overline{λ}}_{1}} ) {C}^{\overline{\_}} - \\ \frac{{E}_{a 11} {t}_{a}}{2 {E}_{c 11} {t}_{c}} {l}_{e} {\overline{λ}}_{3} ( 1 - {v}_{c 13} {v}_{c 31} ) ( {e}^{{\overline{λ}}_{3}} + {e}^{{\overline{λ}}_{3} + {\overline{λ}}_{1}} ) {B}^{\overline{\_}} - \\ \frac{{E}_{a 11} {t}_{a}}{2 {E}_{c 11} {t}_{c}} {l}_{e} {\overline{λ}}_{3} ( 1 - {v}_{c 13} {v}_{c 31} ) ( {e}^{{\overline{λ}}_{3} + 2 {\overline{λ}}_{1}} - {e}^{{\overline{λ}}_{3} + {\overline{λ}}_{1}} ) {A}^{\overline{\_}} + \\ \frac{{l}_{e} {\overline{λ}}_{1} {\overline{λ}}_{3} {e}^{{\overline{λ}}_{3} + {\overline{λ}}_{1}}}{2 {E}_{c 11} {t}_{c}} ( \frac{( 1 - {v}_{c 13} {v}_{c 31} )}{\overline{γ}} ( {E}_{a 11} {t}_{a} + 2 \overline{γ} {{φ}^{\overline{\_}}}_{P} {χ}_{P} ) ) + \\ \frac{{l}_{e} {\overline{λ}}_{1} {\overline{λ}}_{3} {e}^{{\overline{λ}}_{3} + {\overline{λ}}_{1}}}{2 {E}_{c 11} {t}_{c}} ( {χ}_{T} ( 1 - {{φ}^{\overline{\_}}}_{P} ) ( {α}_{c 11} + {α}_{c 33} {v}_{c 31} ) ) .\end{matrix} \qquad ( 32 )$$

Shape Functions and Derivatives within the Bonded Region The shape functions and their derivatives are expressed with the following equations:

$$\begin{matrix}\frac{{N}_{a} ( \overline{x} , {{φ}^{\overline{\_}}}_{P} )}{{l}_{e} {{Φ}^{\overline{\_}}}_{a}} = - ( 1 - {v}_{a 13} {v}_{a 31} ) ( \frac{{e}^{- {\overline{λ}}_{3} \overline{x}} {D}^{\overline{\_}}}{{\overline{λ}}_{3}} + \frac{- {e}^{{\overline{λ}}_{3} \overline{x}} {C}^{\overline{\_}}}{{\overline{λ}}_{3}} + \frac{{e}^{- {\overline{λ}}_{1} \overline{x}} {B}^{\overline{\_}}}{{\overline{λ}}_{1}} + \\ \frac{- {e}^{{\overline{λ}}_{1} \overline{x}} {A}^{\overline{\_}}}{{\overline{λ}}_{1}} + \frac{\overline{x}}{\overline{γ}} ) + x {χ}_{T} ( 1 - {{φ}^{\overline{\_}}}_{P} ) ( {α}_{a 33} {v}_{a 31} + {α}_{a 11} ) , \\ \frac{{N}_{c} ( \overline{x} , {{φ}^{\overline{\_}}}_{P} )}{l {{Φ}^{\overline{\_}}}_{c}} = \frac{{E}_{a 11} {t}_{a} ( 1 - {v}_{c 13} {v}_{c 31} )}{2 {E}_{c 11} {t}_{c}} ( \frac{{e}^{- {\overline{λ}}_{3} \overline{x}} {D}^{\overline{\_}}}{{\overline{λ}}_{3}} - \frac{{e}^{{\overline{λ}}_{3} \overline{x}} {C}^{\overline{\_}}}{{\overline{λ}}_{3}} + \\ \frac{{e}^{- {\overline{λ}}_{1} \overline{x}} {B}^{\overline{\_}}}{{\overline{λ}}_{1}} - \frac{{e}^{{\overline{λ}}_{1} \overline{x}} {A}^{\overline{\_}}}{{\overline{λ}}_{1}} ) + \frac{\overline{x} ( 1 - {v}_{c 13} {v}_{c 31} )}{{E}_{c 11} {t}_{c}} \\ ( {{φ}^{\overline{\_}}}_{P} {χ}_{P} + \frac{{E}_{a 11} {t}_{a}}{2 \overline{γ}} ) + \overline{x} {χ}_{T} ( 1 - {{φ}^{\overline{\_}}}_{P} ) ( {α}_{c 33} {v}_{c 31} + {α}_{c 11} ) .\end{matrix} \\ \begin{matrix}\frac{{B}_{a} ( \overline{x} , {{φ}^{\overline{\_}}}_{P} )}{{l}_{e} {{Φ}^{\overline{\_}}}_{a}} = ( 1 - {v}_{a 13} {v}_{a 31} ) ( {e}^{- {\overline{λ}}_{3} \overline{x}} {D}^{\overline{\_}} + {e}^{{\overline{λ}}_{3} \overline{x}} {C}^{\overline{\_}} + {e}^{- {\overline{λ}}_{1} \overline{x}} {B}^{\overline{\_}} + {e}^{{\overline{λ}}_{1} \overline{x}} {A}^{\overline{\_}} - \frac{1}{\overline{γ}} ) + \\ {χ}_{T} ( 1 - {{φ}^{\overline{\_}}}_{P} ) ( {α}_{a 33} {v}_{a 31} + {α}_{a 11} ) \\ \frac{{B}_{c} ( \overline{x} , {{φ}^{\overline{\_}}}_{P} )}{{l}_{e} {{Φ}^{\overline{\_}}}_{c}} = - ( 1 - {v}_{a 13} {v}_{a 31} ) \frac{{E}_{a 11} {t}_{a}}{2 {E}_{c 11} {t}_{c}} \\ ( {e}^{- {\overline{λ}}_{3} \overline{x}} {D}^{\overline{\_}} + {e}^{{\overline{λ}}_{3} \overline{x}} {C}^{\overline{\_}} + {e}^{- {\overline{λ}}_{1} \overline{x}} {B}^{\overline{\_}} + {e}^{{\overline{λ}}_{1} \overline{x}} {A}^{\overline{\_}} - \frac{1}{\overline{γ}} ) + \\ \frac{{{φ}^{\overline{\_}}}_{P} {χ}_{P} ( 1 - {v}_{c 13} {v}_{c 31} )}{{E}_{c 11} {t}_{c}} + {χ}_{T} ( 1 - {{φ}^{\overline{\_}}}_{P} ) ( {α}_{c 33} {v}_{c 31} + {α}_{c 11} )\end{matrix} \qquad ( 33 )$$

### Nomenclature

lₑ Length of current sub-element, m
t_{κ} Material thicknesses of component κ, m
x Sub-element coordinate measured from the left edge, m
y Sub-element coordinate measured from the lower edge, m
Nₐ, N_{c} Shape functions
Bₐ, B_{c} Shape function derivatives
σ_{κ11(x)} Longitudinal stress in component κ, Pa
σ_{κ22(x,y)} Transverse stress in component κ, Pa τ_{κ12(x)} Shear stress in component κ, Pa
E_{κii} Orthotropic engineering moduli of component κ; Pa
G_{b12} Shear modulus of the adhesive, Pa
α_{κii} Orthotropic thermal expansion coefficient of component κ, C.°⁻¹
v_{κij} Poisson's ratios of component κ
P Mechanical load applied to the element, per unit depth, N m⁻¹
P₁, P₂ Mechanical load DOFs inside the element, per unit depth, N m⁻¹
ΔT Temperature change from a reference temperature, C.°
x̅ Sub-element natural coordinate x/lₑ measured from the left edge of the sub-element
γ̅, λ̅₁, λ̅₃ Dimensionless system parameters
φ̅_{P}, Ψ̅_{P} Dimensionless mechanical load parameters
φ̅_{T}, Ψ̅_{T} Dimensionless thermal load parameters
φ̅ₜₒₜₐₗ, Ψ̅ₜₒₜₐₗ Dimensionless total load parameters
φ̅_{P}, Ψ̅_{P} Dimensionless mechanical load fractions
A̅, B̅, C̅, D̅ Dimensionless coefficients
Φ̅ₐ, Φ̅_{c} Intermediate coefficients Ξ̅ₐ Ξ̅_{c} Intermediate coefficients
q₁,q₂,q₃,q₄,qₑ Displacement degrees of freedom
κ κ=[abc] (no sum) Subscript representing central adherend (a), adhesive (b), and outer adherend (c) respectively

What is claimed is:

1. A method for determining kinematic or kinetic field quantities in a structural joint, the method comprising:
representing at least a portion of the structural joint as a finite element;
embedding a shape function specific to the structural joint in the finite element; and
determining at least one kinematic and kinetic field quantity based on the shape function specific to the structural joint.

2. The method of claim 1 wherein the shape function is non-linear.

3. The method of claim 1 further comprising determining the shape function specific to the structural joint based on a displacement field specific to the structural joint.

4. The method of claim 1 wherein the shape function is adaptive.

5. The method of claim 4 wherein determining at least one kinematic and kinetic field quantity based on the shape function specific to the structural joint includes determining instantaneous values of the at least one kinematic and kinetic field quantity and wherein the shape function is adaptive to the instantaneous values of the at least one kinematic and kinetic field quantity.

6. The method of claim 1 wherein the kinematic field quantity comprises at least one of displacement, velocity and strain.

7. The method of claim 1 wherein the kinetic field quantity comprises at least one of stress, temperature and moisture concentration.

8. The method of claim 1 wherein the finite element is adaptive.

9. The method of claim 8 wherein the structural joint has a state of degradation and wherein the finite element is adaptive to the state of degradation of the structural joint.

10. The method of claim 1 wherein the structural joint has a state of degradation and wherein the finite element has a configuration based on the state of degradation.

11. The method of claim 1 wherein the entire structural joint is represented by the finite element.

12. The method of claim 1 wherein the structural joint includes a connected region and an adjacent region and wherein the portion of the structural joint includes the adjacent region.

13. A computer-readable storage medium having information stored thereon for directing a computer to perform the method of claim 1.

14. A system for determining kinematic or kinetic field quantities in a structural joint, the system comprising:
a computing machine configured to
represent at least a portion of the structural joint as a finite element,
embed a shape function specific to the structural joint in the finite element, and
determine at least one kinematic and kinetic field quantity based on the shape function specific to the structural joint.

15. The system of claim 14 wherein the shape function is non-linear.

16. The system of claim 14 wherein the computing machine is further configured to determine the shape function specific to the structural joint based on a displacement field specific to the structural joint.

17. The system of claim 14 wherein determining at least one kinematic and kinetic field quantity based on the shape function specific to the structural joint includes determining instantaneous values of the at least one kinematic and kinetic field quantity and wherein the shape function is adaptive to the instantaneous values of the at least one kinematic and kinetic field quantity.

18. The system of claim 14 wherein the structural joint has a state of degradation and wherein the finite element is adaptive to the state of degradation of the structural joint.

19. The system claim 14 wherein the structural joint has a state of degradation and wherein the finite element has a configuration based on the state of degradation.
